(19) United States
(12) Patent Application Publication
(10) Pub. No.: US 2025/0095393 A1
(43) Pub. Date: Mar. 20, 2025

(54) TEXT-AUGMENTED OBJECT CENTRIC RELATIONSHIP DETECTION

(71) Applicant: ADOBE INC., SAN JOSE, CA (US)

(72) Inventors: Ziyan Yang, Houston, TX (US); Kushal Kafle, Sunnyvale, CA (US); Zhe Lin, Clyde Hill, WA (US); Scott Cohen, Cupertino, CA (US); Zhihong Ding, Davis, CA (US)

(21) Appl. No.: 18/470,778

(22) Filed: Sep. 20, 2023

(51) Int. Cl. G06V 20/70; G06F 40/205; G06V 10/25; G06V 10/774

(52) U.S. Cl. CPC G06V 20/70; G06F 40/205; G06V 10/25; G06V 10/774

(57) ABSTRACT

A method, apparatus, and non-transitory computer readable medium for image processing are described. Embodiments of the present disclosure obtain an image and an input text including a subject from the image and a location of the subject in the image. An image encoder encodes the image to obtain an image embedding. A text encoder encodes the input text to obtain a text embedding. An image processing apparatus based on the present disclosure generates an output text based on the image embedding and the text embedding. In some examples, the output text includes a relation of the subject to an object from the image and a location of the object in the image.

### BACKGROUND

The following relates generally to image processing, and more specifically to relationship detection using machine learning. Digital image processing refers to the use of a computer to edit a digital image using an algorithm or a processing network. In some cases, image processing software can be used for various tasks, such as image editing, enhancement, restoration, image generation, etc. Some image processing systems implement machine learning techniques to detect one or more objects in an input image and then generate a scene graph comprising the one or more objects.

In digital image processing and computer vision, scene graph generation relates to the task of predicting the class and locations for possible objects in a scene (e.g., a digital image) and relations between the objects. For example, a user provides an image as a query, and a relation detection model tries to identify candidate objects in the image and predict relations between the identified candidate objects.

### SUMMARY

The present disclosure describes systems and methods for image processing. Embodiments of the present disclosure include an image processing apparatus configured to obtain an image and an input text including a subject from the image (e.g., “a person”) and a location of the subject in the image. The image processing apparatus is trained to generate an output text that includes an object, a relation of the subject to the object, and the location of the object (e.g., output text is “a person wearing hoodie”). In some examples, the output text, generated via two-step decoding process, includes coordinates information of a bounding box corresponding to the object (e.g., “hoodie”) to represent the object's location.

A method, apparatus, and non-transitory computer readable medium for image processing are described. One or more embodiments of the method, apparatus, and non-transitory computer readable medium include obtaining an image and an input text including a subject from the image and a location of the subject in the image; encoding the image to obtain an image embedding; encoding the input text to obtain a text embedding; and generating an output text based on the image embedding and the text embedding, wherein the output text includes a relation of the subject to an object from the image and a location of the object in the image.

A method, apparatus, and non-transitory computer readable medium for image processing are described. One or more embodiments of the method, apparatus, and non-transitory computer readable medium include receiving training data including a training image, a training input text including a subject from the training image, a ground-truth relation of the subject to an object from the training image, and a ground-truth location of the object in the training image and training, using the training data, a machine learning model to generate an output text that includes a relation of the subject to the object and a location of the object in the training image.

An apparatus and method for image processing are described. One or more embodiments of the apparatus and method include at least one processor; at least one memory including instructions executable by the at least one processor; and a machine learning model comprising parameters stored in the at least one memory, wherein the machine learning model is trained to generate an output text including a relation of a subject to an object from an image and a location of the object in the image based on an input text including the subject from the image and a location of the subject in the image.

### BRIEF DESCRIPTION OF THE DRAWINGS

FIG. 1 shows an example of an image processing system according to aspects of the present disclosure.

FIG. 2 shows an example of a method for relationship detection application according to aspects of the present disclosure.

FIG. 3 shows an example of input to an image processing apparatus and corresponding output according to aspects of the present disclosure.

FIG. 4 shows an example of image processing outcome according to aspects of the present disclosure.

FIG. 5 shows an example of a method for image processing according to aspects of the present disclosure.

FIG. 6 shows an example of an image processing apparatus according to aspects of the present disclosure.

FIG. 7 shows an example of a machine learning model according to aspects of the present disclosure.

FIG. 8 shows an example of subject-conditional relation detection according to aspects of the present disclosure.

FIG. 9 shows an example of a method for training a machine learning model according to aspects of the present disclosure.

FIG. 10 shows an example of a method for training a machine learning model according to aspects of the present disclosure.

FIG. 11 shows an example of training samples according to aspects of the present disclosure.

FIG. 12 shows an example of training data according to aspects of the present disclosure.

FIG. 13 shows an example of training a machine learning model using grounded training samples according to aspects of the present disclosure.

FIG. 14 shows an example of training a machine learning model using ungrounded training samples according to aspects of the present disclosure.

FIG. 15 shows an example of concatenating bounding box and text tokens according to aspects of the present disclosure.

FIG. 16 shows an example of sequence-to-sequence model for text generation according to aspects of the present disclosure.

FIG. 17 shows an example of decoding relation-object pairs and bounding boxes according to aspects of the present disclosure.

FIG. 18 shows an example of decoding unknown bounding box annotations according to aspects of the present disclosure.

FIG. 19 shows an example of a method for training a machine learning model according to aspects of the present disclosure.

FIG. 20 shows an example of a two-stage decoding process according to aspects of the present disclosure.

FIG. 21 shows an example of a computing device according to aspects of the present disclosure.

### DETAILED DESCRIPTION

The present disclosure describes systems and methods for image processing. Embodiments of the present disclosure include an image processing apparatus configured to obtain an image and an input text including a subject from the image (e.g., “a person”) and a location of the subject in the image. The image processing apparatus is trained to generate an output text that includes an object, a relation of the subject to the object and the location of the object (e.g., output text is “a person wearing hoodie”). In some examples, the output text, generated via two-step decoding process, includes coordinates information of a bounding box corresponding to the object (e.g., “hoodie”) to represent the object's location.

In some embodiments, a machine learning model is trained using fully grounded training samples and text-augmented training samples. Fully grounded training samples contain [symbol] subject, relation, object [symbol] triplets with corresponding box locations for subjects and objects. Additionally, text-augmented training samples (i.e., ungrounded training data or ungrounded samples) contain noisy [symbol] subject, relation, object [symbol] triplets extracted automatically from textual image captions. With regards to ungrounded trained data, ground-truth object locations are not provided (e.g., box annotations for objects in training images are not available).

Recently, machine learning has been applied in relationship detection tasks. For example, conventional object detectors extract a group of candidate objects along with their bounding boxes based on an image. Then relations between objects are predicted among the group of candidate objects. Training conventional scene graph generation models depends on fully annotated datasets. It is time-consuming and costly to obtain fully annotated datasets for training conventional scene graph generation models. Additionally, the training datasets have a cap limiting the number of object categories that were seen at training. Accordingly, the accuracy for text and box prediction using conventional models is decreased for relationship prediction when an object category is unseen at inference time.

Embodiments of the present disclosure include an image processing apparatus configured to perform object-centric relationship detection by obtaining an image and an input text comprising a subject and a location of the subject (e.g., location coordinates or a bounding box). The image processing apparatus generates an output text based on the image and the input text. The output text includes one or more relation-object pairs. That is, given an image and a subject, a machine learning model based on the present disclosure generates outputs including possible subject-predicate-object triplets along with their bounding boxes. A bounding box corresponding to an object of the image provides location information of the object (e.g., via box coordinates information).

In some examples, given a query identifying a subject (e.g., “person”) and the location of the subject, the machine learning model is trained to predict a relationship of an object of an image towards the subject and its location (e.g., predicts relationship “holding racquet” and the location of object “racquet”). In an embodiment, the machine learning model takes image, text, and bounding box (location information of a subject) and generates an output text including relation-object pairs and locations of the objects.

At training time, embodiments of the present disclosure uniquely combine fully grounded training samples (i.e., with box annotations) and ungrounded caption samples (i.e., without box annotations) for training the machine learning model. That is, the machine learning model is under different training modes of supervision. In an embodiment, the machine learning model includes an image encoder, a text encoder, a multi-modal fusion encoder, and an auto-regressive decoder.

With regards to fully grounded training samples, the training images are associated with annotations for subjects, objects, relations and bounding boxes. In some examples, a bounding box indicates location information (e.g., boundary information, coordinates information) for a corresponding subject or an object. As for ungrounded caption samples, text-augmented training dataset includes images annotated with textual captions. For example, [symbol] subject, relation, object [symbol] triplets are automatically extracted from textual captions annotated in the images. Text-augmented training samples lack box annotations (i.e., no box locations for objects). For example, a textual caption of an ungrounded caption sample is “a woman working on a laptop”. Here, the subject is “woman” and the object is “a laptop”. Neither the subject nor the object has box annotations. In some cases, a pseudo-box is obtained for the subject (i.e., unverified boxes for subjects). In some cases, ungrounded caption samples are also referred to as text-augmented training samples.

Unlike conventional models, the image processing apparatus based on the present disclosure performs subject-conditional relation detection and generates enumerating relations, objects, and boxes conditioned on a subject in an image. Through combining box annotations for a portion of training data with a large amount of ungrounded image-text data, embodiments of the present disclosure expand the number and variety of relation-object pairs. This way, the training cost is decreased due to a reduced amount of box annotations needed for training.

In some examples, the machine learning model generates a relation graph given a query object. The machine learning model leverages auto-regressive sequence prediction and predicts relation-object pairs and box locations by considering the box locations as additional discrete output tokens in a sequence. By incorporating image-text paired data, relation prediction performance is improved even when there are no annotations in the training set for these relationships.

Embodiments of the present disclosure can be used in the context of object selection, image search, object-oriented image editing applications, etc. For image editing applications, manipulating an object in an image (e.g., removing or re-positioning an object) may look unrealistic because conventional models fail to account for related objects. In some embodiments, the image processing apparatus can be used to detect related objects and apply the same editing operation to the related objects in addition to the query object. For example, if a subject “person” is removed, an image editing tool based on the present disclosure removes the umbrella held by the person (i.e., predicts umbrella to be an object related to the subject “person”).

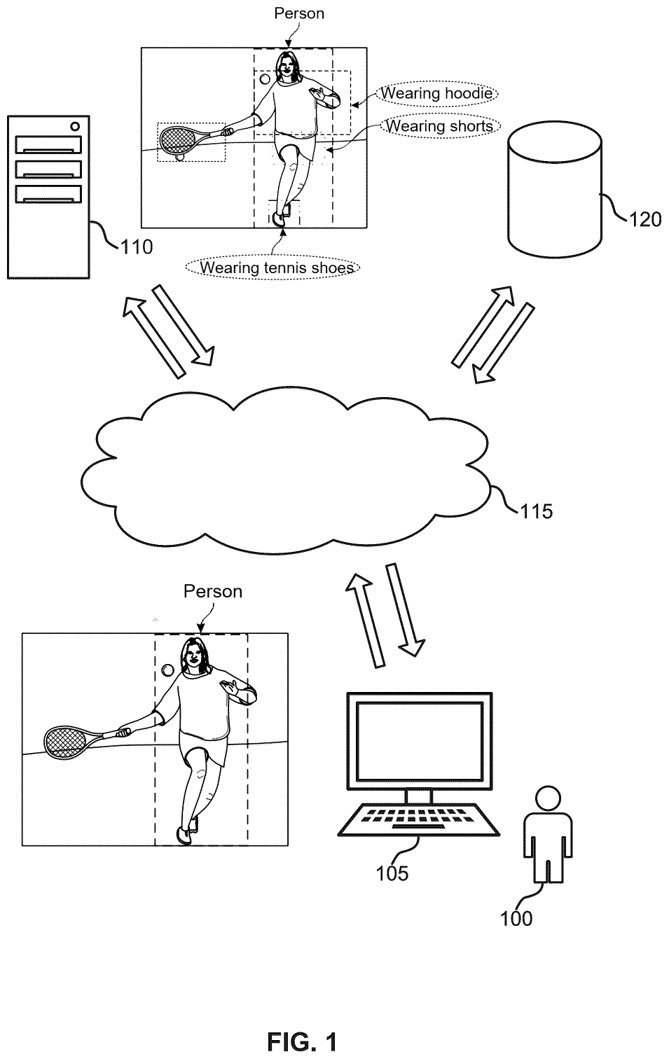

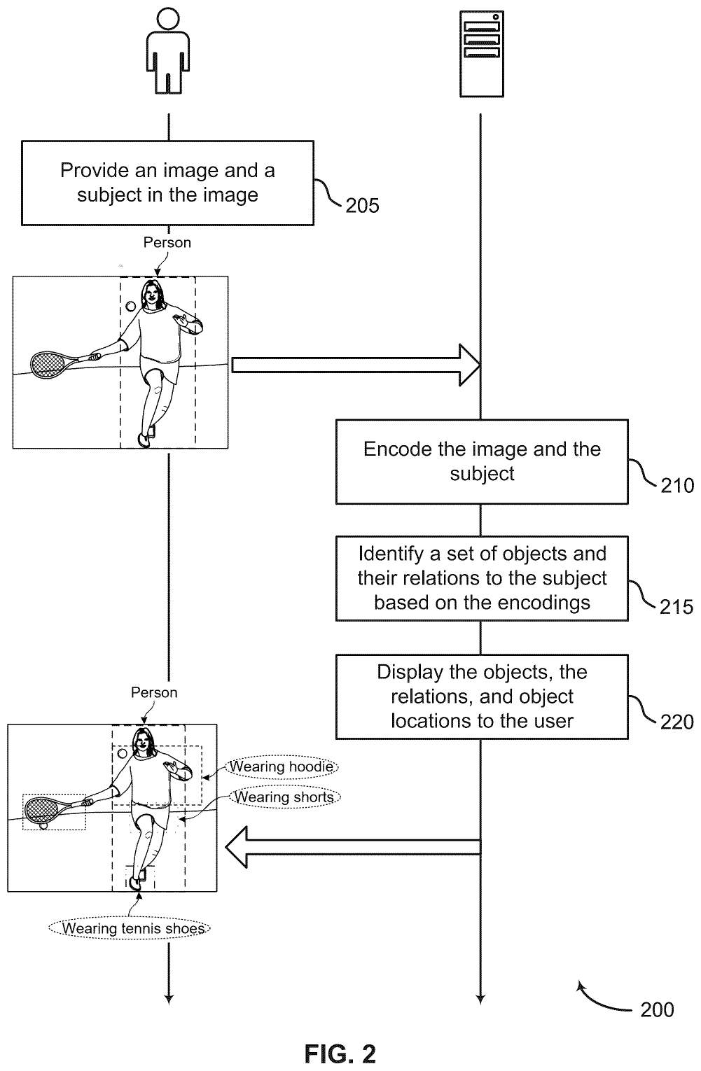

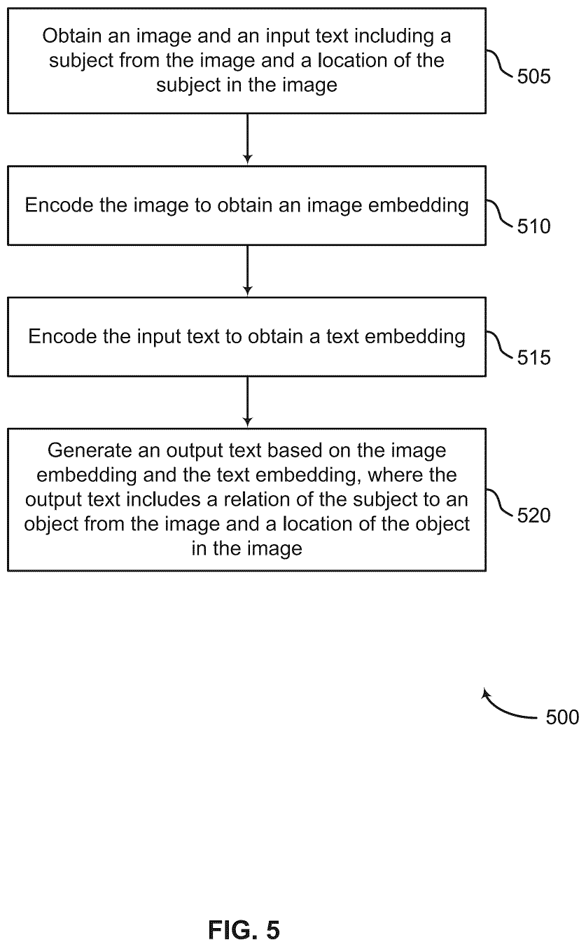

In some examples, an image processing apparatus based on the present disclosure receives an image and a subject in the image, identifies a set of objects and predicts their relations to the subject and locations of these objects. An example application in the relationship detection context is provided with reference to FIGS. 2-4. Details regarding the architecture of an example image processing system are provided with reference to FIGS. 1 and 6-8. Details regarding the process of relationship detection are provided with reference to FIG. 5.

### Relationship Detection

In FIGS. 1-5, a method, apparatus, and non-transitory computer readable medium for image processing are described. One or more embodiments of the method, apparatus, and non-transitory computer readable medium include obtaining an image and an input text including a subject from the image and a location of the subject in the image; encoding the image to obtain an image embedding; encoding the input text to obtain a text embedding; and generating an output text based on the image embedding and the text embedding, wherein the output text includes a relation of the subject to an object from the image and a location of the object in the image.

Some examples of the method, apparatus, and non-transitory computer readable medium further include combining the image embedding and the text embedding to obtain a combined embedding, wherein the output text is generated based on the combined embedding.

Some examples of the method, apparatus, and non-transitory computer readable medium further include generating a first portion of the output text indicating the relation. Some examples further include generating a second portion of the output text indicating the location of the object based on the relation.

In some examples, the location of the subject comprises coordinates for a bounding box surrounding the subject. In some examples, the input text comprises a symbol between the subject and the location of the subject, and wherein the output text comprises the symbol between the relation and the location of the object.

Some examples of the method, apparatus, and non-transitory computer readable medium further include obtaining the subject in the image. Some examples further include generating the input text based on the obtaining.

Some examples of the method, apparatus, and non-transitory computer readable medium further include modifying the image to obtain a modified image based on the subject, the object, and the relation of the subject to the object.

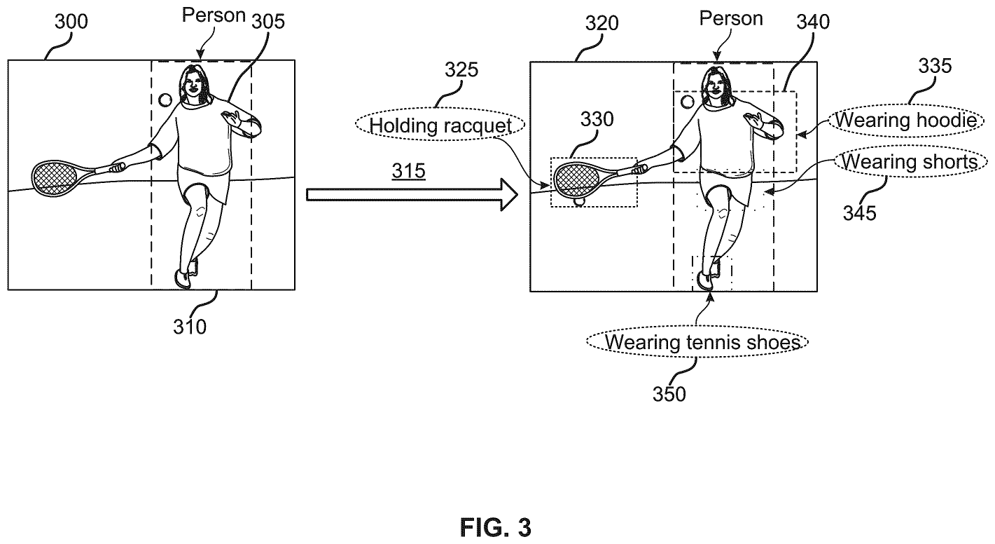

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIGS. 3, 4, and 6.

In an example shown in FIG. 1, an image and an input text are provided and transmitted to image processing apparatus 110, e.g., via user device 105 and cloud 115. The input text includes a subject from the image and a location of the subject in the image. For example, the subject is “person” and its location is indicated by a bounding box surrounding the subject (e.g., the dash-line box). In some examples, the input text includes the location coordinates corresponding to the bounding box of the subject. Image processing apparatus 110 encodes the image to obtain an image embedding and encodes the input text to obtain a text embedding.

Image processing apparatus 110 generates, via a decoder, an output text based on the image embedding and the text embedding. The output text includes a relation of the subject to an object from the image and a location of the object in the image. In the above example, image processing apparatus 110 generates at least three instances of output text, e.g., “person wearing hoodie”, “person wearing shorts”, and “person wearing tennis shoes”. An identified object is “hoodie” and the relation of the subject to the object is “wear” or “wearing”. The location of object “hoodie” is indicated by an additional bounding box surrounding the object “hoodie”. In some cases, the output text includes location coordinates of the object. Image processing apparatus 110 generates a second output text and a third output text corresponding to “shorts” and “shoes”, respectively. The one or more output texts are returned to user 100 via cloud 115 and user device 105.

User device 105 may be a personal computer, laptop computer, mainframe computer, palmtop computer, personal assistant, mobile device, or any other suitable processing apparatus. In some examples, user device 105 includes software that incorporates an image processing application (e.g., query answering, image editing, relationship detection). In some examples, the image editing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a user interface may be represented in code which is sent to the user device 105 and rendered locally by a browser. The process of using the image processing apparatus 110 is further described with reference to FIG. 2.

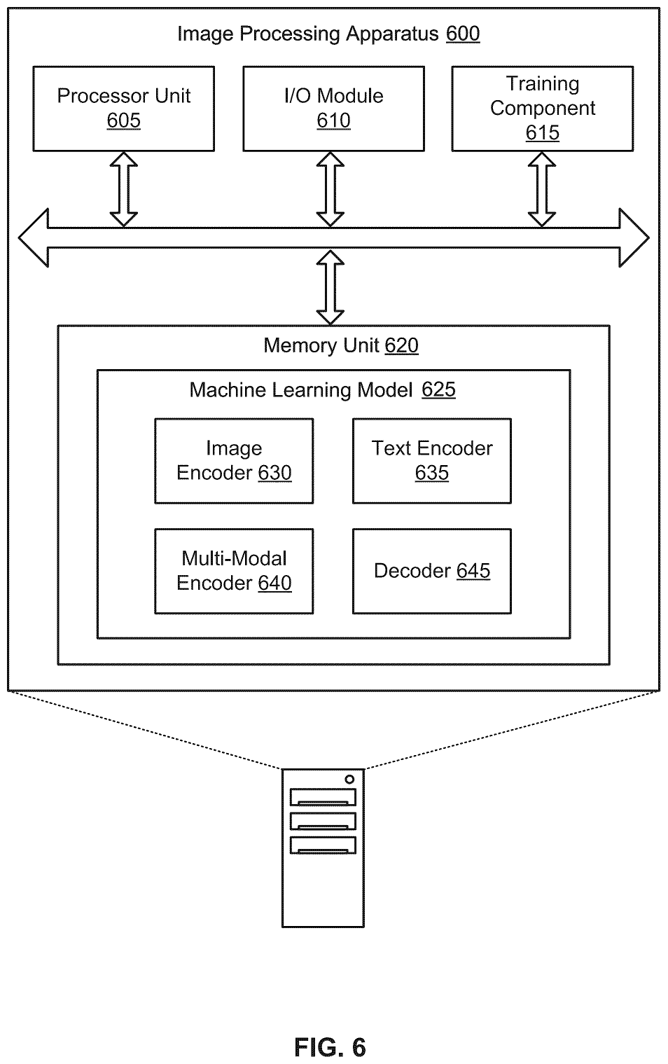

Image processing apparatus 110 includes a computer implemented network comprising an image encoder, a text encoder, a multi-modal encoder, and a decoder. Image processing apparatus 110 may also include a processor unit, a memory unit, an I/O module, and a training component. The training component is used to train a machine learning model (or an image processing network). Additionally, image processing apparatus 110 can communicate with database 120 via cloud 115. In some cases, the architecture of the image processing network is also referred to as a network, a machine learning model, or a network model. Further detail regarding the architecture of image processing apparatus 110 is provided with reference to FIGS. 6-8. Further detail regarding the operation of image processing apparatus 110 is provided with reference to FIGS. 2 and 5.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with database controller. In other cases, database controller may operate automatically without user interaction.

FIG. 2 shows an example of a method 200 for image generation application according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the user provides an image and a subject in the image. In some cases, the operations of this step refer to, or may be performed by, a user as described with reference to FIG. 1. In some examples, the subject “person” is given and the user is interested in knowing the object(s) that have a relationship with “person” and the associated relationships. The location of the subject is also provided (e.g., a bounding box indicating coordinates information of the subject).

At operation 210, the system encodes the image and the subject in the image to obtain an image embedding and a text embedding. In some cases, the operations of this step refer to, or may be performed by, an image processing apparatus as described with reference to FIGS. 1, 3, 4, and 6.

At operation 215, the system identifies a set of objects and their relations to the subject based on the image and text encodings (or embeddings). In some cases, the operations of this step refer to, or may be performed by, an image processing apparatus as described with reference to FIGS. 1, 3, 4, and 6.

In some examples, the image processing apparatus can be used to perform object removal by obtaining the relationships that exist between objects in the image. The image processing apparatus generates suggestions and automate editing operations. For example, if the user wants to remove the person, without knowing related objects from the image for the person, an image editing tool would only apply editing operations on the person and generate the image with a racquet floating in the air. By knowing the relation between object “racquet” and the subject “person”, an image editing tool based on the present disclosure applies the same operation such as “moving” or “deletion” and move or delete the person and the racquet simultaneously.

At operation 220, the system displays the objects, the relationship between each object and the given subject, and object locations to the user. In some cases, the operations of this step refer to, or may be performed by, an image processing apparatus as described with reference to FIGS. 1, 3, 4, and 6.

In some cases, the image processing apparatus is configured to predict object-to-object relationships in the image. Given the image and a query object (e.g., the subject “person”), the image processing apparatus predicts relations and objects related to the given subject. This task is referred to as object-centric relation detection. In some cases, the image processing apparatus may be referred to as a relation detection apparatus.

FIG. 3 shows an example of input to an image processing apparatus 315 and corresponding output from image processing apparatus 315 according to aspects of the present disclosure. The example shown includes image 300, subject 305, subject location 310, image processing apparatus 315, modified image 320, first relation output 325, first object location 330, second relation output 335, second object location 340, third relation output 345, and fourth relation output 350. Image processing apparatus 315 is an example of, or includes aspects of, the corresponding element described with reference to FIGS. 1, 4, and 6.

FIG. 3 shows an example of input to image processing apparatus 315 and corresponding output. Given a query phrase “person” and the corresponding location of the person, image processing apparatus 315 predicts relationship phrases such as “holding racquet” and the location of the racquet. For example, image 300 includes subject 305 (“person”) and subject location 310. Subject location 310 is based on a bounding box that surrounds subject 305.

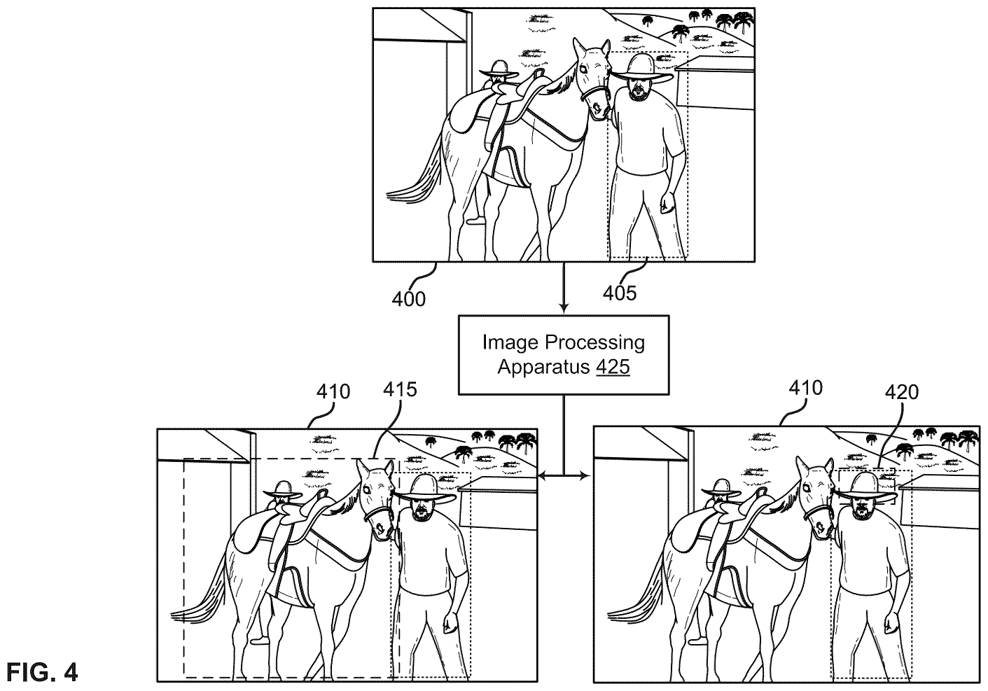

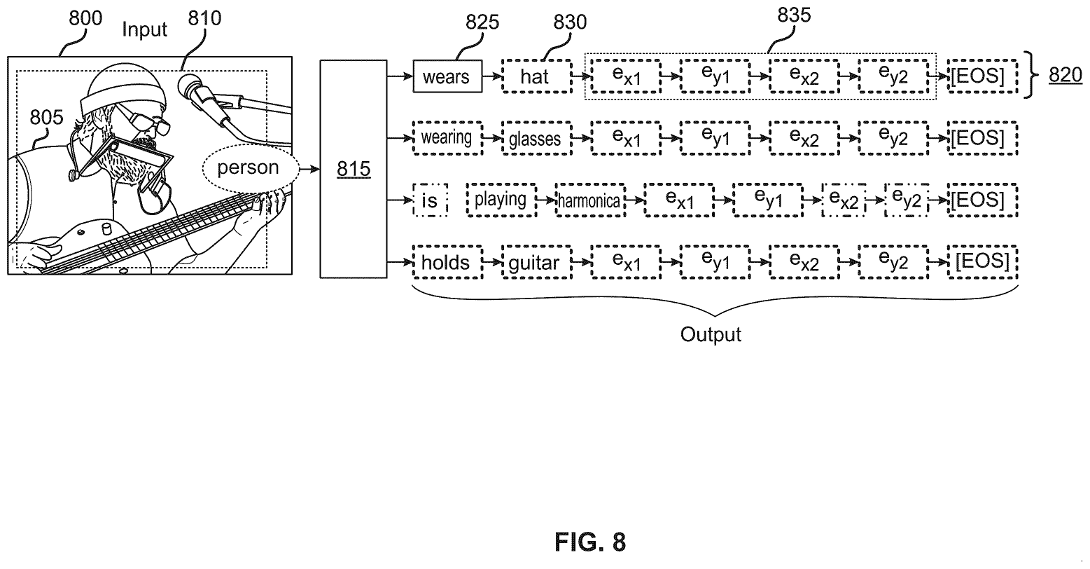

Image 300 is an example of, or includes aspects of, the corresponding element described with reference to FIGS. 4, 8, 13, and 14. Subject 305 is an example of, or includes aspects of, the corresponding element described with reference to FIGS. 8, and 12-14. Subject location 310 is an example of, or includes aspects of, the corresponding element described with reference to FIG. 8.

In an embodiment, image processing apparatus 315 generates modified image 320. Modified image 320 includes and/or is associated with first relation output 325, first object location 330, second relation output 335, second object location 340, third relation output 345, and fourth relation output 350. Modified image 320 is an example of, or includes aspects of, the corresponding element described with reference to FIG. 4. For example, image processing apparatus 315 predicts an output text that includes a relation of subject 305 to an object from image 300 and a location of the object in image 300. One or more objects from image 300 include racquet, hoodie, shorts, etc. First object location 330 refers to a location of object “racquet”. Second object location 340 refers to a location of object “hoodie”.

For example, first relation output 325 is “holding racquet”. Second relation output 335 is “wearing hoodie”. Third relation output 345 is “wearing shorts”. Fourth relation output 350 is “wearing tennis shoes”.

FIG. 4 shows an example of image 400 processing outcome according to aspects of the present disclosure. The example shown includes image 400, first bounding box 405, modified image 410, second bounding box 415, third bounding box 420, and image processing apparatus 425. Image processing apparatus 425 is an example of, or includes aspects of, the corresponding element described with reference to FIGS. 1, 3, and 6.

In an example shown in FIG. 4, image 400 includes a subject “man”. Image 400 includes first bounding box 405 corresponding to the subject “man”. Image processing apparatus 425 takes the subject and first bounding box 405 as input and generates modified image 410. On the left, modified image 410 includes a relation of the subject to a first object from image 400 (e.g., “interact with horse”) and a location of the first object in image 400. The location of the first object (“horse”) is indicated by second bounding box 415.

On the right, modified image 410 includes a relation of the subject to a second object from image 400 (e.g., “wear cowboy hat”) and a location of the second object in image 400. The location of the second object (“cowboy hat”) is indicated by third bounding box 420.

Image 400 is an example of, or includes aspects of, the corresponding element described with reference to FIGS. 3, 8, 13, and 14. Modified image 410 is an example of, or includes aspects of, the corresponding element described with reference to FIG. 3.

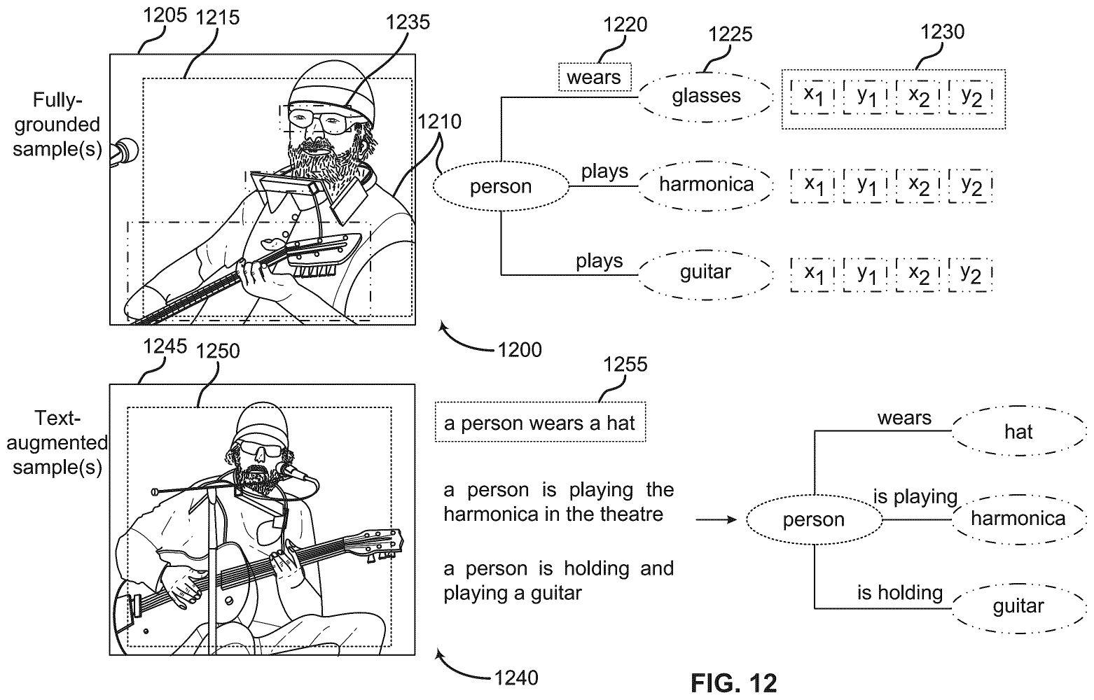

First bounding box 405 is an example of, or includes aspects of, the corresponding element described with reference to FIG. 12. Second bounding box 415 is an example of, or includes aspects of, the corresponding element described with reference to FIG. 12. Third bounding box 420 is an example of, or includes aspects of, the corresponding element described with reference to FIG. 12.

FIG. 5 shows an example of a method 500 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, the system obtains an image and an input text including a subject from the image and a location of the subject in the image. In some cases, the operations of this step refer to, or may be performed by, a machine learning model as described with reference to FIGS. 6-8, 13, 14, and 16.

In some embodiments, a machine learning mode is configured for subject-conditional relation detection and the model is conditioned on an input subject. The machine learning model is trained to predict the relations of the subject to other objects in a scene along with their locations (i.e., locations of objects).

In some examples, the machine learning model is trained based on the Open Images dataset (e.g., OIv6-SCORD benchmark). The training and testing splits involve [symbol] subject, relation, object [symbol] triplets. In an embodiment, given a subject, an auto-regressive model predicts its relations, objects, and object locations by casting this output as a sequence of tokens. The machine learning model produces an enumeration of relation-object pairs when conditioned on a subject on the Open Images dataset benchmark.

At operation 510, the system encodes the image to obtain an image embedding. In some cases, the operations of this step refer to, or may be performed by, an image encoder as described with reference to FIGS. 6, 7, 13, and 14.

At operation 515, the system encodes the input text to obtain a text embedding. In some cases, the operations of this step refer to, or may be performed by, a text encoder as described with reference to FIGS. 6, 7, 13, and 14.

At operation 520, the system generates an output text based on the image embedding and the text embedding, where the output text includes a relation of the subject to an object from the image and a location of the object in the image. In some cases, the operations of this step refer to, or may be performed by, a machine learning model as described with reference to FIGS. 6-8, 13, 14, and 16.

In some embodiments, given an input image and a subject, the machine learning model is trained to predict a relation-object pair along with the object location auto-regressively. At test time, a decoder applies two-step decoding to generate a diverse set of relation-object pairs for a given test input image-subject pair. During training, the machine learning model leverages, via a training component, images annotated exclusively with textual captions to increase its capabilities on rare or unseen [symbol] subject, relation, object [symbol] triplets. For example, even when the training data contains no annotations for holding umbrella, the training data is augmented with image-text data to provide an ungrounded example for holding umbrella. Due to unified decoding, the machine learning model not only predicts but also provides accurate grounding in the form of a bounding box location for holding umbrella during inference.

### Network Architecture

In FIGS. 6-8, an apparatus and method for image processing are described. One or more embodiments of the apparatus and method include at least one processor; at least one memory including instructions executable by the at least one processor; and a machine learning model comprising parameters stored in the at least one memory, wherein the machine learning model is trained to generate an output text including a relation of a subject to an object from an image and a location of the object in the image based on an input text including the subject from the image and a location of the subject in the image.

Some examples of the apparatus and method further include an image encoder configured to encode the image to obtain an image embedding. Some examples of the apparatus and method further include a text encoder configured to encode the input text to obtain a text embedding.

Some examples of the apparatus and method further include a multi-modal encoder configured to combine an image embedding and a text embedding to obtain a combined embedding, wherein the output text is generated based on the combined embedding.

Some examples of the apparatus and method further include a decoder configured to generate a first portion of the output text indicating the relation and a second portion of the output text indicating the location of the object based on the relation.

Some examples of the apparatus and method further include a training component configured to compute a loss function based on training data and to train the machine learning model based on the loss function. In some examples, the machine learning model obtains the subject in the image, wherein the input text is generated based on the obtaining.

FIG. 6 shows an example of an image processing apparatus 600 according to aspects of the present disclosure. The example shown includes image processing apparatus 600, processor unit 605, I/O module 610, training component 615, memory unit 620, and machine learning model 625. Image processing apparatus 600 is an example of, or includes aspects of, the corresponding element described with reference to FIGS. 1, 3, and 4.

Processor unit 605 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor unit 605 is configured to operate a memory array using a memory controller. In other cases, a memory controller is integrated into the processor. In some cases, processor unit 605 is configured to execute computer-readable instructions stored in a memory to perform various functions. In some embodiments, processor unit 605 includes special purpose components for modem processing, baseband processing, digital signal processing, or transmission processing.

Examples of memory unit 620 include random access memory (RAM), read-only memory (ROM), or a hard disk. Examples of memory unit 620 include solid state memory and a hard disk drive. In some examples, memory unit 620 is used to store computer-readable, computer-executable software including instructions that, when executed, cause a processor to perform various functions described herein. In some cases, memory unit 620 contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within memory unit 620 store information in the form of a logical state.

In some examples, at least one memory unit 620 includes instructions executable by the at least one processor unit 605. Memory unit 620 includes machine learning model 625 or stores parameters of machine learning model 625.

I/O module 610 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 610 includes a user interface. A user interface may enable a user to interact with a device. In some embodiments, the user interface may include an audio device, such as an external speaker system, an external display device such as a display screen, or an input device (e.g., remote control device interfaced with the user interface directly or through an I/O controller module). In some cases, a user interface may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna.

According to some embodiments of the present disclosure, image processing apparatus 600 includes a computer implemented artificial neural network (ANN). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

According to some embodiments, image processing apparatus 600 includes a convolutional neural network (CNN) for image processing (e.g., image encoding, image decoding). CNN is a class of neural networks that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

According to some embodiments, training component 615 receives training data including a training image, a training input text including a subject from the training image, a ground-truth relation of the subject to an object from the training image, and a ground-truth location of the object in the training image. In some examples, training component 615 trains, using the training data, a machine learning model 625 to generate an output text that includes a relation of the subject to the object and a location of the object in the training image.

In some examples, training component 615 obtains additional training data including an additional training image, an additional training input including an additional subject from the additional training image, an additional ground-truth relation of the additional subject to an additional object from the additional training image, where the machine learning model 625 is trained based on the additional training data.

In some examples, training component 615 obtains a set of captions. Training component 615 parses a caption of the set of captions, where the additional training input is obtained based on the parsing. In some examples, training component 615 computes a loss function based on the predicted output text, the ground-truth relation, and the ground-truth location, where the machine learning model 625 is trained based on the loss function.

According to some embodiments, machine learning model 625 obtains an image and an input text including a subject from the image and a location of the subject in the image. In some examples, machine learning model 625 generates an output text based on the image embedding and the text embedding, where the output text includes a relation of the subject to an object from the image and a location of the object in the image. In some examples, machine learning model 625 generates a first portion of the output text indicating the relation. Machine learning model 625 generates a second portion of the output text indicating the location of the object based on the relation.

In some examples, the location of the subject includes coordinates for a bounding box surrounding the subject. In some examples, the input text includes a symbol between the subject and the location of the subject, and where the output text includes the symbol between the relation and the location of the object. In some examples, machine learning model 625 obtains the subject in the image. Machine learning model 625 generates the input text based on the obtaining. In some examples, machine learning model 625 modifies the image to obtain a modified image based on the subject, the object, and the relation of the subject to the object.

In some examples, machine learning model 625 generates a predicted output text based on the image embedding and the text embedding. According to some embodiments, parameters of machine learning model 625 are stored in the at least one memory (e.g., memory unit 620), wherein machine learning model 625 is trained to generate an output text including a relation of a subject to an object from an image and a location of the object in the image based on an input text including the subject from the image and a location of the subject in the image. In some examples, the machine learning model 625 obtains the subject in the image, where the input text is generated based on the obtaining.

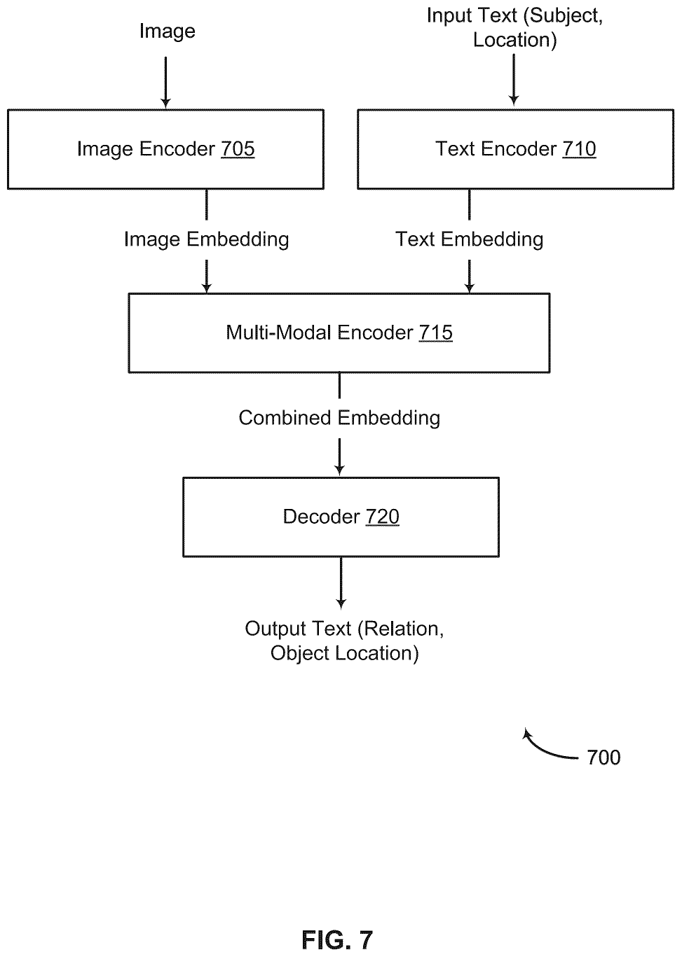

In one embodiment, machine learning model 625 includes image encoder 630, text encoder 635, multi-modal encoder 640, and decoder 645. Machine learning model 625 is an example of, or includes aspects of, the corresponding element described with reference to FIGS. 7, 8, 13, 14, and 16.

According to some embodiments, image encoder 630 encodes the image to obtain an image embedding. For example, image encoder 630 encodes the training image to obtain an image embedding. Image encoder 630 is an example of, or includes aspects of, the corresponding element described with reference to FIGS. 7, 13, and 14.

According to some embodiments, text encoder 635 encodes the input text to obtain a text embedding. For example, text encoder 635 encodes the training input text to obtain a text embedding. Text encoder 635 is an example of, or includes aspects of, the corresponding element described with reference to FIGS. 7, 13, and 14.

According to some embodiments, multi-modal encoder 640 combines the image embedding and the text embedding to obtain a combined embedding, where the output text is generated based on the combined embedding. For example, multi-modal encoder 640 combines the image embedding and the text embedding to obtain a combined embedding, where the predicted output text is generated based on the combined embedding. Multi-modal encoder 640 is an example of, or includes aspects of, the corresponding element described with reference to FIGS. 7, 13, 14, and 16.

According to some embodiments, decoder 645 is configured to generate a first portion of the output text indicating the relation and a second portion of the output text indicating the location of the object based on the relation. Decoder 645 is an example of, or includes aspects of, the corresponding element described with reference to FIGS. 7, 13, 14, and 16.

FIG. 7 shows an example of a machine learning model 700 according to aspects of the present disclosure. The example shown includes machine learning model 700, image encoder 705, text encoder 710, multi-modal encoder 715, and decoder 720. Machine learning model 700 is an example of, or includes aspects of, the corresponding element described with reference to FIGS. 6, 8, 13, 14, and 16.

In some embodiments, machine learning model 700 takes images, text, and bounding boxes as inputs and integrates information from different modalities for detecting related objects for given subjects. Images and text (e.g., image patches, sentences) are represented as sequences of tokens. Bounding boxes are also represented as position tokens and are concatenated with text inputs. Machine learning model 700 predicts text (i.e., relation-object pairs) and locations (i.e., position tokens) for given localized subjects input as a sequence of tokens.

In some embodiments, machine learning model 700 is trained to generate an output text including a relation of a subject to an object from an image and a location of the object in the image based on an input text including the subject from the image and a location of the subject in the image.

Image encoder 705 is configured to encode the image to obtain an image embedding. Image encoder 705 is an example of, or includes aspects of, the corresponding element described with reference to FIGS. 6, 13, and 14. Text encoder 710 is configured to encode the input text to obtain a text embedding. Text encoder 710 is an example of, or includes aspects of, the corresponding element described with reference to FIGS. 6, 13, and 14.

In some examples, image encoder 705 is denoted as Fᵥ, text encoder 710 is denoted as Fₜ, and multi-modal encoder 715 is denoted as Fₘ. These encoders are pre-trained encoders. Multi-modal encoder 715 is also referred to as a multi-modal fusion encoder. Machine learning model 700 includes a joint vision-language transformer using additional grounded supervision with box coordinates as input tokens. In some embodiments, the transformer-based machine learning model 700 contains one 12-layer vision transformer as the image encoder 705, one 6-layer text transformer as the text encoder 710, one 6-layer multi-modal (transformer) encoder 715 to combine image and text information and one 6-layer (transformer) decoder 720 to generate target sequences. The hidden size for each layer is 768 and the number of attention heads is 12.

Multi-modal encoder 715 is configured to combine an image embedding and a text embedding to obtain a combined embedding, wherein the output text is generated based on the combined embedding. Multi-modal encoder 715 is an example of, or includes aspects of, the corresponding element described with reference to FIGS. 6, 13, 14, and 16.

In some embodiments, decoder 720 follows the same architecture as the multi-modal transformer encoder using masked self-attention layers. Parameters of decoder 720 are initialized using the weights from the multi-modal transformer encoder. Decoder 720 is configured to generate a first portion of the output text indicating the relation and a second portion of the output text indicating the location of the object based on the relation. Decoder 720 is an example of, or includes aspects of, the corresponding element described with reference to FIGS. 6, 13, 14, and 16.

Transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

FIG. 8 shows an example of subject-conditional relation detection according to aspects of the present disclosure. The example shown includes image 800, subject 805, subject location 810, machine learning model 815, output text 820, relation 825, object 830, and object location 835.

An example in FIG. 8 shows the inputs and outputs of machine learning model 815 during test time. Machine learning model 815 takes subject 805 in image 800 and subject location 810 of subject 805 as inputs. In some examples, subject location 810 is represented by a bounding box that provides coordinates information of subject 805. Here, a given subject 805 is “person”. Machine learning model 815 generates output text 820. Output text 820 includes a relation 825 of the subject to an object 830 from the image 800 and object location 835 in the image 800. In the above example, the output text is “wears hat eₓ₁, e_{y1}, eₓ₂, e_{y2}”. Relation 825 of the subject to an object 830 is “wears hat”. eₓ₁, e_{y1}, eₓ₂, e_{y2} is object location 835.

Some embodiments cast subject-conditional relation detection as a sequence decoding task. Given the subject 805 in image 800, machine learning model 815 predicts relation-object predicates and the corresponding locations. Machine learning model 815 is an example of, or includes aspects of, the corresponding element described with reference to FIGS. 6, 7, 13, 14, and 16.

In some examples, image 800 includes one or more pairwise relations between objects in a scene. Given an object of interest, i.e., subject 805, machine learning model 815 is trained to predict its predicates and locations of objects. In some cases, a user wants to crop the person in image 800 to create a composite in a different background. There is a need to crop the person along with objects that the person interacts with, such as the guitar, the harmonica, the hat, and the glasses. Such a task of finding objects and predicates that relate to a given subject is referred to as subject-conditional relation detection.

Image 800 is an example of, or includes aspects of, the corresponding element described with reference to FIGS. 3, 4, 13, and 14. Subject 805 is an example of, or includes aspects of, the corresponding element described with reference to FIGS. 3, and 12-14. Subject location 810 is an example of, or includes aspects of, the corresponding element described with reference to FIG. 3.

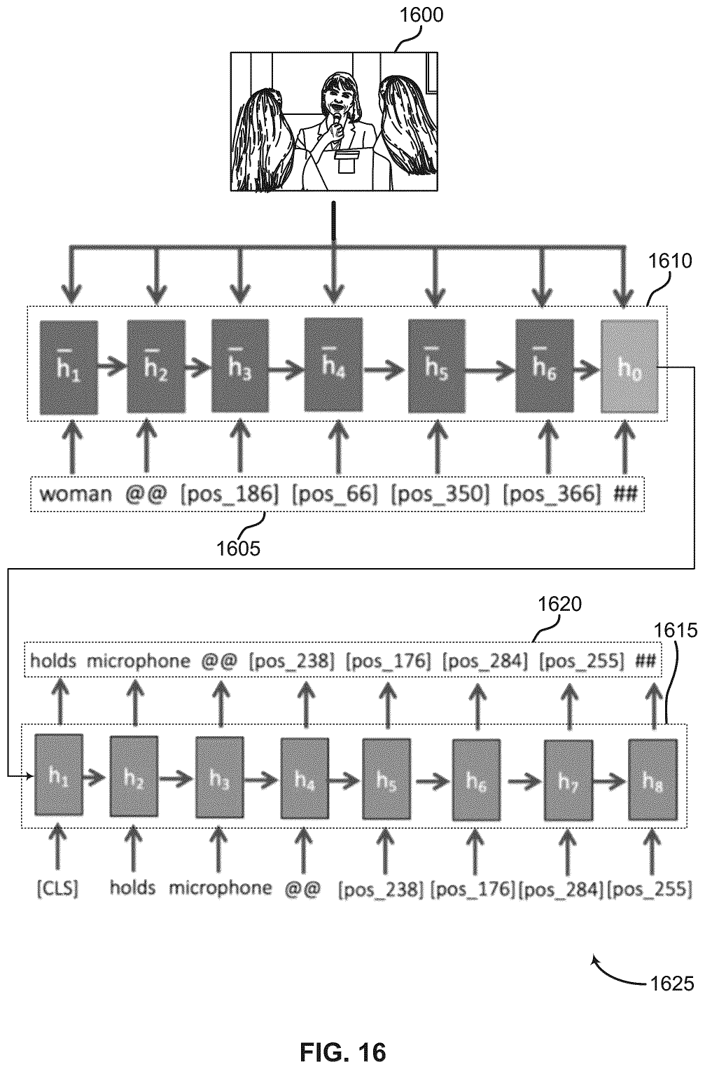

Output text 820 is an example of, or includes aspects of, the corresponding element described with reference to FIG. 16. Relation 825 is an example of, or includes aspects of, the corresponding element described with reference to FIGS. 12-14. Object 830 is an example of, or includes aspects of, the corresponding element described with reference to FIGS. 12-14. Object location 835 is an example of, or includes aspects of, the corresponding element described with reference to FIG. 12.

### Training

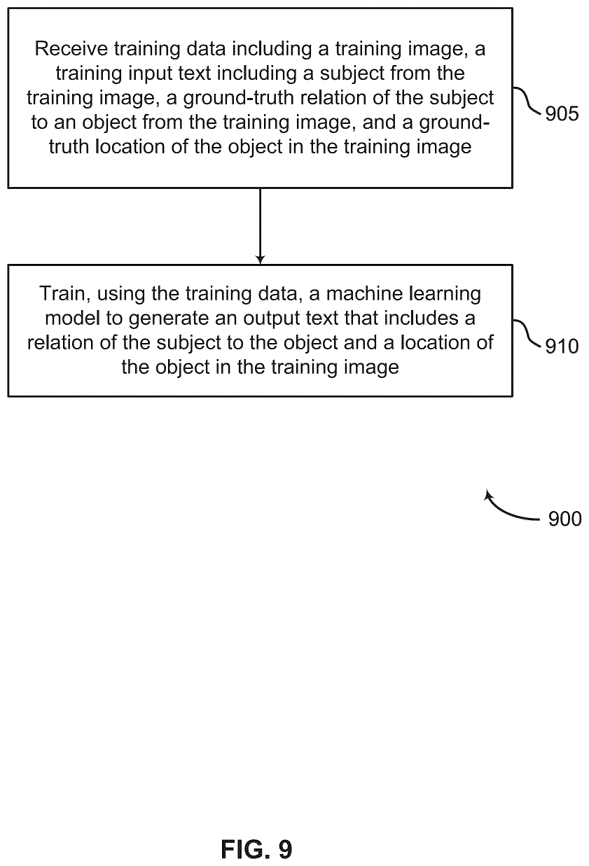

In FIGS. 9-19, a method, apparatus, and non-transitory computer readable medium for image processing are described. One or more embodiments of the method, apparatus, and non-transitory computer readable medium include receiving training data including a training image, a training input text including a subject from the training image, a ground-truth relation of the subject to an object from the training image, and a ground-truth location of the object in the training image and training, using the training data, a machine learning model to generate an output text that includes a relation of the subject to the object and a location of the object in the training image.

Some examples of the method, apparatus, and non-transitory computer readable medium further include obtaining additional training data including an additional training image, an additional training input including an additional subject from the additional training image, an additional ground-truth relation of the additional subject to an additional object from the additional training image, wherein the machine learning model is trained based on the additional training data.

Some examples of the method, apparatus, and non-transitory computer readable medium further include obtaining a plurality of captions. Some examples further include parsing a caption of the plurality of captions, wherein the additional training input is obtained based on the parsing.

Some examples of the method, apparatus, and non-transitory computer readable medium further include encoding the training image to obtain an image embedding. Some examples further include encoding the training input text to obtain a text embedding. Some examples further include generating a predicted output text based on the image embedding and the text embedding. Some examples further include computing a loss function based on the predicted output text, the ground-truth relation, and the ground-truth location, wherein the machine learning model is trained based on the loss function.

Some examples of the method, apparatus, and non-transitory computer readable medium further include combining the image embedding and the text embedding to obtain a combined embedding, wherein the predicted output text is generated based on the combined embedding.

Some examples of the method, apparatus, and non-transitory computer readable medium further include generating a first portion of the output text indicating the relation. Some examples further include generating a second portion of the output text indicating the location of the object based on the relation.

FIG. 9 shows an example of a method 900 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system receives training data including a training image, a training input text including a subject from the training image, a ground-truth relation of the subject to an object from the training image, and a ground-truth location of the object in the training image. In some cases, the operations of this step refer to, or may be performed by, a training component as described with reference to FIG. 6.

In some embodiments, a machine learning model (e.g., a subject-conditional relation detection model) is trained using two different training modes of supervision, e.g., fully grounded training samples and ungrounded training samples.

In some embodiments, the machine learning model is trained and supervised by fully-grounded data. In some examples, training data is a combination of Visual Genome, Flickr30k and Open Images V6 (also known as OIv6). Visual Genome contains 100k images annotated with 2.3M relations between objects with annotated box locations. Flickr30k contains 30k images with bounding boxes annotated with corresponding referring expressions. In some examples, a language dependency parser is applied to extract [symbol] subject, relation, object [symbol] triplets from the referring expressions of Flickr30k, and map the subject and object mentioned in a triplet to phrase the bounding boxes. For example, <man, rides, horse> has a box for subject “man” and object “horse”. OIv6 has 526k images with annotations for subjects, objects, relations and boxes. Some relation-object pairs in OIv6 are not true relations between two different objects (e.g., “A is B” type of relations), and the corresponding images are therefore filtered out. The filtered OIv6 dataset contains 120k images with annotations for subjects, objects, relations, and bounding boxes. In some cases, a bounding box indicates location information (e.g., boundary information, coordinates information) for a corresponding subject or an object.

At operation 910, the system trains, using the training data, a machine learning model to generate an output text that includes a relation of the subject to the object and a location of the object in the training image. In some cases, the operations of this step refer to, or may be performed by, a training component as described with reference to FIG. 6.

In some embodiments, the machine learning model includes a set of transformer models comprising an (input) image encoder, a text encoder, a multi-modal fusion encoder, and an (output) auto-regressive decoder.

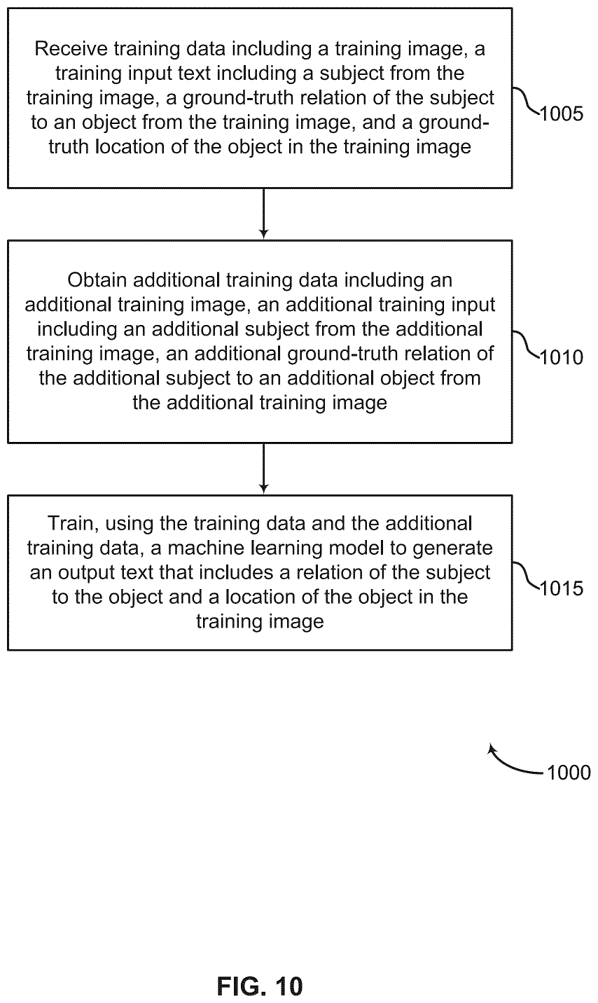

FIG. 10 shows an example of a method 1000 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system receives training data including a training image, a training input text including a subject from the training image, a ground-truth relation of the subject to an object from the training image, and a ground-truth location of the object in the training image. In some cases, the operations of this step refer to, or may be performed by, a training component as described with reference to FIG. 6.

At operation 1010, the system obtains additional training data including an additional training image, an additional training input including an additional subject from the additional training image, an additional ground-truth relation of the additional subject to an additional object from the additional training image. In some cases, the operations of this step refer to, or may be performed by, a training component as described with reference to FIG. 6.

In some embodiments, the machine learning model is supervised by text-augmented training data that include images annotated with textual captions. For example, [symbol] subject, relation, object [symbol] triplets are automatically extracted from text-augmented data, e.g., from textual captions annotated in the training images. Text-augmented training data is used to train the machine learning model and there are no box annotations (indicating locations) included in the text-augmented training dataset. In some examples, the text-augmented training data is a combination of COCO and Conceptual Captions datasets (CC3M+CC12M referred together as “CC”). The COCO dataset includes 120k images, 5 captions for each image, and bounding box annotations for 80 categories. Although the COCO dataset contains box annotations, the COCO dataset is treated as an ungrounded data source because the COCO dataset does not contain a mapping between object annotations and references to objects in text descriptions, and additionally object boxes contained in COCO dataset are only annotated for 80 object categories, which does not cover the full range of objects mentioned in captions. Additionally, the COCO dataset is applied along with Localized Narrative descriptions to obtain more varied subjects, objects and relations. This combination of ungrounded image-text data from COCO and CC provides additional supervision from an external source.

In some embodiments, the machine learning model extracts the [symbol] subject, relation, object [symbol] triplets using image-text pairs with a dependency parser. Grounded language-image pre-training (GLIP) is applied to generate noisy box locations for the input subjects in the [symbol] subject, relation, object [symbol] triplets, while leaving target objects ungrounded without corresponding box locations.

At operation 1015, the system trains, using the training data and the additional training data, a machine learning model to generate an output text that includes a relation of the subject to the object and a location of the object in the training image. In some cases, the operations of this step refer to, or may be performed by, a training component as described with reference to FIG. 6.

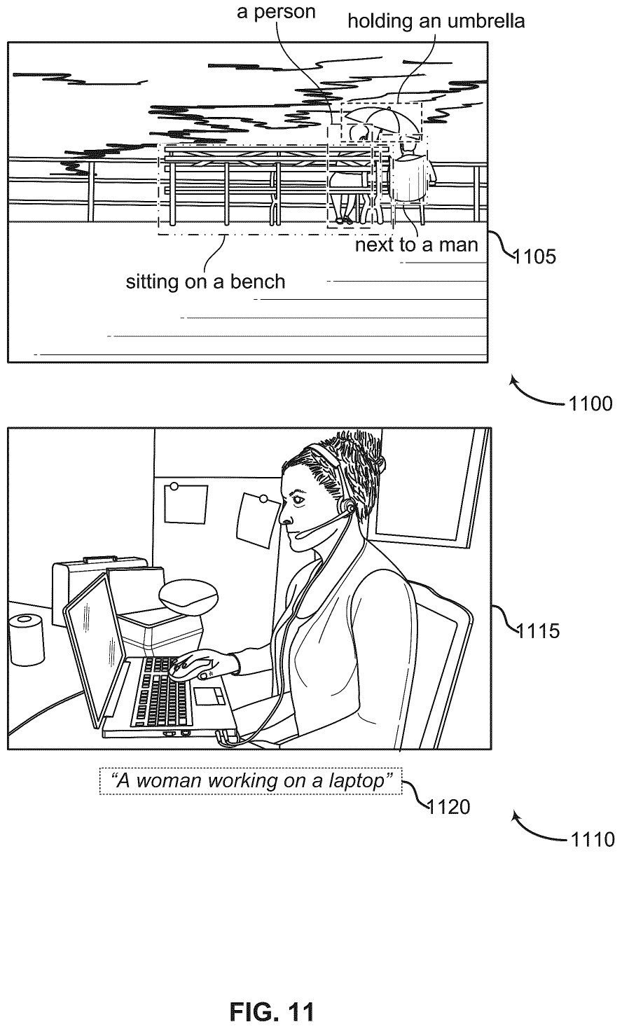

FIG. 11 shows an example of training samples according to aspects of the present disclosure. The example shown includes grounded training sample 1100, first training image 1105, ungrounded training sample 1110, second training image 1115, and caption 1120.

In an example shown in FIG. 11, grounded training sample 1100 includes first training image 1105 combined with a grounded subject (“a person”) and the subject's related objects (“sitting on a bench”, “holding an umbrella”, “next to a man”). First training image 1105 is an example of, or includes aspects of, the corresponding element described with reference to FIG. 12.

For example, ungrounded training sample 1110 includes second training image 1115 and a caption 1120 (“A woman working on a laptop”). Second training image 1115 is an example of, or includes aspects of, the corresponding element described with reference to FIG. 12. Caption 1120 is an example of, or includes aspects of, the corresponding element described with reference to FIG. 12.

FIG. 12 shows an example of training data according to aspects of the present disclosure. The example shown includes first training sample 1200, first training image 1205, subject 1210, first bounding box 1215, relation 1220, object 1225, object location 1230, second bounding box 1235, second training sample 1240, second training image 1245, third bounding box 1250, and caption 1255.

Two types of annotated samples are used for training the machine learning model, i.e., fully grounded samples where relation-object pairs as well as object locations are provided, and text-augmented samples where the images are also annotated with image captions. Text-augmented samples mention a larger set of object categories than datasets that are fully annotated with [symbol] subject, relation, object [symbol] triplets. First training sample 1200 is an example of a fully-grounded sample. Second training sample 1240 is an example of a text-augmented sample.

For example, first training sample 1200 includes first training image 1205, subject 1210, and first bounding box 1215. First bounding box 1215 indicates a location of the subject 1210 in first training image 1205. The subject 1210 is “person”. A training input text includes subject 1210 from first training image 1205, a ground-truth relation (i.e., relation 1220) of the subject 1210 to an object 1225 from the first training image 1205, and a ground-truth location of the object 1225 in the first training image 1205. The object 1225 is glasses. Second bounding box 1235 indicates the ground-truth location of the object 1225 (i.e., object location 1230 of object “glasses”). Here, as shown in FIG. 12, object location 1230 is denoted as x₁, y₁, x₂, y₂. In this example, the output text, generated by the image processing apparatus, is “person wears glasses at x₁, y₁, x₂, y₂”.

For example, second training sample 1240 includes second training image 1245, third bounding box 1250, and caption 1255. Caption 1255 is “a person wears a hat”. Third bounding box 1250 indicates a location of a subject (e.g., “person”). With regards to text-augmented samples, there are no bounding box annotations associated with object(s) in second training image 1245.

Some embodiments include a benchmark based on the Open Images dataset such that models trained on provided training split cannot easily take advantage of priors in the highly skewed distribution of [symbol] subject, relation, object [symbol] triplets. A strong baseline is provided and leveraging an external dataset containing text annotations can tackle the prediction of relation-object pairs that are unseen during training.

First training image 1205 is an example of, or includes aspects of, the corresponding element described with reference to FIG. 11. Subject 1210 is an example of, or includes aspects of, the corresponding element described with reference to FIGS. 3, 8, 13, and 14.

First bounding box 1215 is an example of, or includes aspects of, the corresponding element described with reference to FIG. 4. Relation 1220 is an example of, or includes aspects of, the corresponding element described with reference to FIGS. 8, 13, and 14. Object 1225 is an example of, or includes aspects of, the corresponding element described with reference to FIGS. 8, 13, and 14. Object location 1230 is an example of, or includes aspects of, the corresponding element described with reference to FIG. 8. Second bounding box 1235 is an example of, or includes aspects of, the corresponding element described with reference to FIG. 4.

Second training image 1245 is an example of, or includes aspects of, the corresponding element described with reference to FIG. 11. Third bounding box 1250 is an example of, or includes aspects of, the corresponding element described with reference to FIG. 4. Caption 1255 is an example of, or includes aspects of, the corresponding element described with reference to FIG. 11.

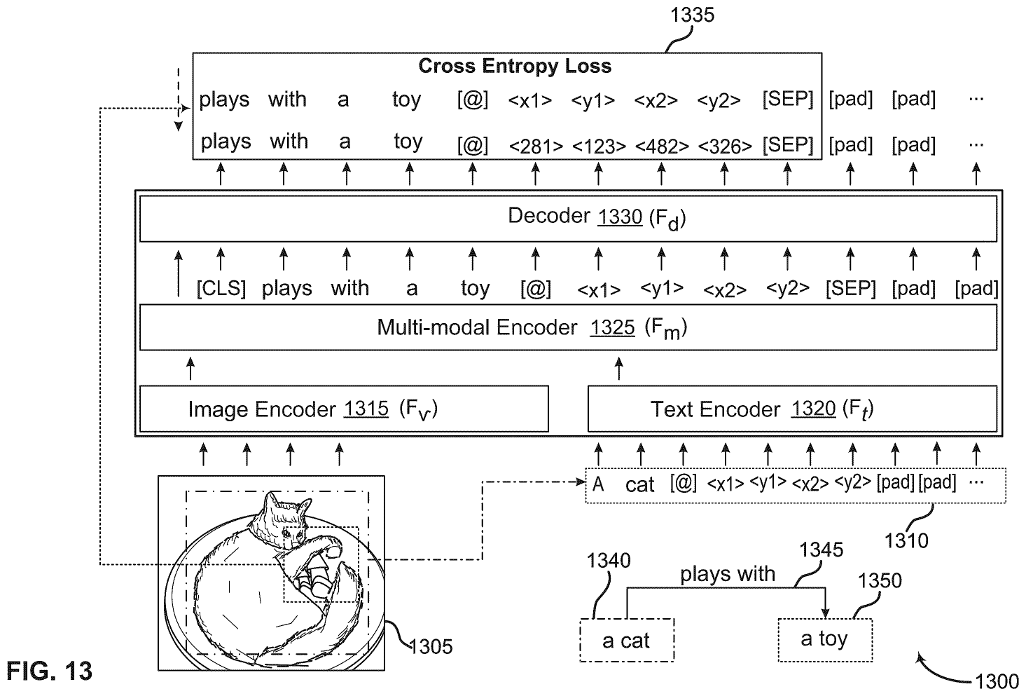

FIG. 13 shows an example of training a machine learning model 1300 using grounded training samples according to aspects of the present disclosure. The example shown includes machine learning model 1300, image 1305, input text 1310, image encoder 1315, text encoder 1320, multi-modal encoder 1325, decoder 1330, loss function 1335, subject 1340, relation 1345, and object 1350. Machine learning model 1300 is an example of, or includes aspects of, the corresponding element described with reference to FIGS. 6-8, 14, and 16.

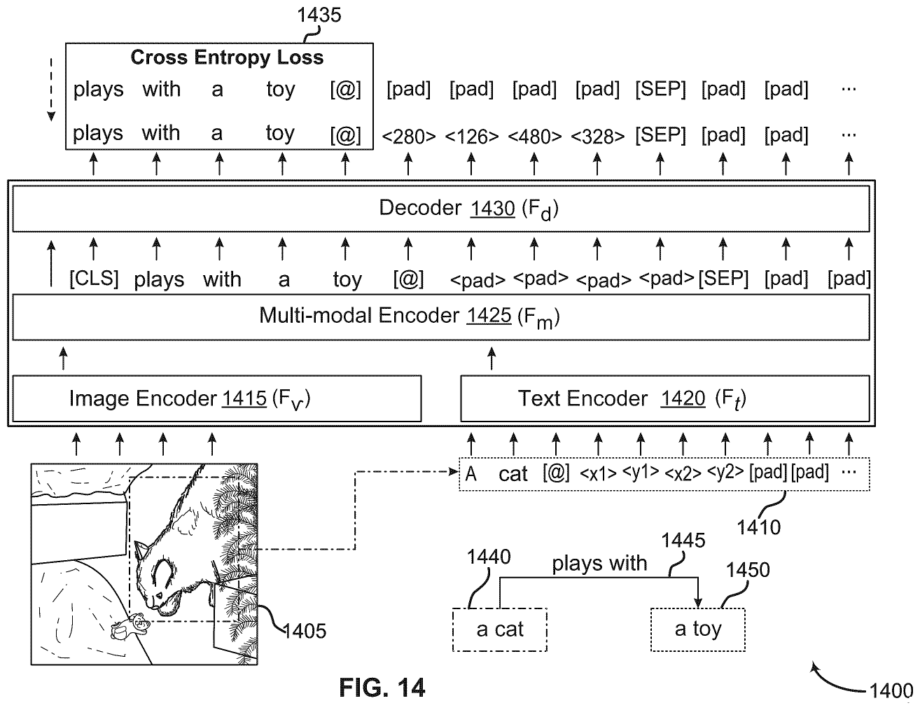

Referring to FIG. 13, in some embodiments, machine learning model 1300 is configured to handle, via a training component, fully grounded training samples including a (subject, relation, object) triplet for which a box location is available for the subject 1340 and the object 1350. For example, input text 1310 includes subject 1340 and the box location for subject 1340. Image 1305 is an example of, or includes aspects of, the corresponding element described with reference to FIGS. 3, 4, 8, and 14. Input text 1310 is an example of, or includes aspects of, the corresponding element described with reference to FIGS. 14 and 16.

In some embodiments, machine learning model 1300 takes image I (i.e., image 1305) and target subject s (i.e., subject 1340) along with its corresponding box location bₛ as input. Machine learning model 1300 is configured to predict a set of possible relations (e.g., including relation 1345), object 1350, and object locations, formulated as follows:

$$\{ 〈 r , o , {b}_{o} 〉 s . t . ∃ 〈 s , r , o 〉 ∈ {Π}_{I} \} \qquad ( 1 )$$

where Πₗ is an enumeration of valid relation triplets of relation r, object o, and box location bₒ in input image I, The box location bₒ corresponds to object o. In some embodiments, machine learning model 1300 (also denoted as Φ) is configured to sample output relation-object predictions from a pre-trained machine learning model that is trained to predict a distribution over possible values as follows:

$$〈 r , o , {b}_{o} 〉 ∼ Φ ( I , s , {b}_{s} ) \qquad ( 2 )$$

Machine learning model 1300 is denoted as Φ and the model is configured to sample output relation-object predictions multiple times to obtain an arbitrary set of predictions { [symbol] rⱼ, oⱼ, bₒ_{ⱼ} [symbol] }. In contrast with conventional scene graph generation methods, where the number of object categories for subject s, relation r, and object o is limited, subject s, relation r, and object o based on the present disclosure are open-vocabulary and modeled as text (input text 1310 and output text) to support an arbitrary set of objects and relations.

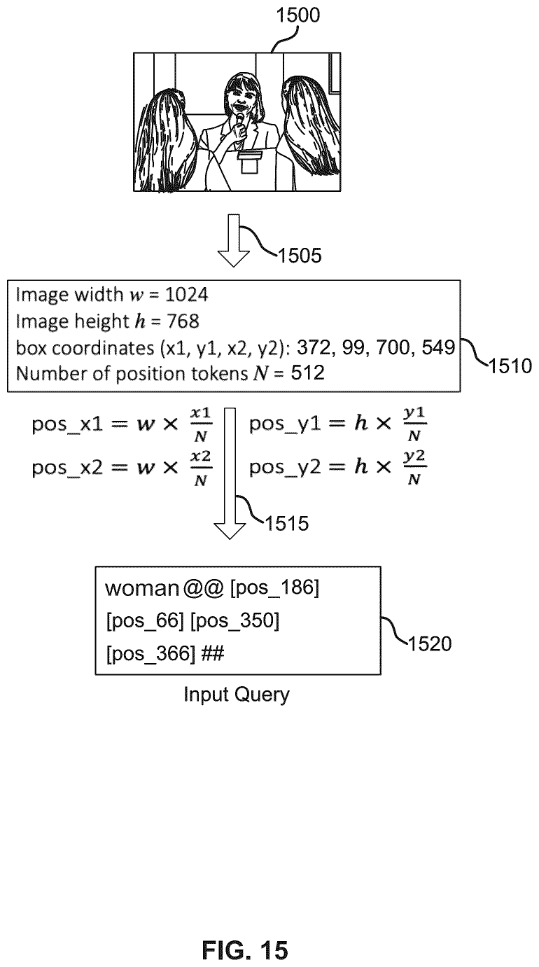

In some embodiments, machine learning model 1300 is configured to perform subject-conditional relation detection and the model is a sequence-to-sequence model. Input to machine learning model 1300 is an image I and an input token sequence representing the input subject s and its box location bₛ, and the output is a sequence of tokens representing the predicted relation-object pair [symbol] r, o [symbol] and the corresponding object location coordinates bₒ. FIG. 13 shows an example of machine learning model 1300 trained with an input fully grounded training sample. The input and output coordinates are discretized to cast the input and output coordinates for the grounded samples as tokens. Detail regarding quantization process is described further in FIG. 15. For example, a set of box coordinates (x₁, y₁, x₂, y₂) and a corresponding image 1305 with height h and width w are provided and machine learning model 1300 discretizes the coordinates as follows:

$$( P \frac{{x}_{1}}{w} , P \frac{{y}_{1}}{h} , P \frac{{x}_{2}}{w} , P \frac{{y}_{2}}{h} ) \qquad ( 3 )$$

where P is a pre-defined number representing the total number of position tokens. Additionally, special separator tokens are added to indicate the start and the end of box coordinates.

In some embodiments, machine learning model 1300 includes an image transformer encoder Fᵥ (i.e., image encoder 1315) which encodes images into a sequence of image features {Iᵢ}ᵢ₌₁^{N}^{ₗ} and a text transformer encoder Fₜ (i.e., text encoder 1320) which encodes subjects with position tokens as a sequence of text features {Tⱼ}ⱼ₌₁^{N}^{_{T}}.

In some embodiments, a multi-modal fusion encoder Fₘ (i.e., multi-modal encoder 1325) is configured to fuse image feature(s) and text feature(s) through cross-attention layers and generates a context vector z. Next, the output context vector z of the multi-modal fusion encoder Fₘ (i.e., multi-modal encoder 1325) is forwarded to a transformer decoder F_{d} (decoder 1330). Image encoder 1315 is an example of, or includes aspects of, the corresponding element described with reference to FIGS. 6, 7, and 14. Text encoder 1320 is an example of, or includes aspects of, the corresponding element described with reference to FIGS. 6, 7, and 14. Multi-modal encoder 1325 is an example of, or includes aspects of, the corresponding element described with reference to FIGS. 6, 7, 14, and 16.

Decoder 1330 is trained auto-regressively to predict a relation 1345, an object 1350, and its corresponding box coordinate locations as a sequence of tokens based on the context vector z. In some examples, the output text includes a relation of the subject to an object from the image and a location of the object (e.g., corresponding box coordinate locations) in the image. Decoder 1330 is an example of, or includes aspects of, the corresponding element described with reference to FIGS. 6, 7, 14, and 16.

In some embodiments, machine learning model 1300 is trained to predict a context vector z=Fₘ(Fᵥ(I), Fₜ(s,bₛ)) and then the model predicts an output relation-object pair along with a bounding box using the auto-regressive transformer decoder [symbol] r, o [symbol] , bₒ=F_{d}(z) based on the context vector z.

In some embodiments, machine learning model 1300 is optimized during training to minimize a loss function L( [symbol] r, o [symbol] , bₒ, F_{d}(z)) to produce a sequence from the transformer decoder F_{d} that matches the true relation-object pair. During inference, predictions are obtained by sampling from the transformer decoder F_{d}: [symbol] r, o [symbol] , bₒ˜F_{d}(z). Loss function 1335 is an example of, or includes aspects of, the corresponding element described with reference to FIG. 14. Loss function 1335 includes a cross-entropy loss.

Some embodiments apply two types of supervision: a first type of fully grounded samples, i.e., fully-grounded data that contains [symbol] subject, relation, object [symbol] triplets with corresponding box locations for subjects and objects, and a second type of samples, i.e., ungrounded data that contain noisy [symbol] subject, relation, object [symbol] triplets extracted automatically from textual image captions. In the second type of ungrounded training data, object locations are not provided and accordingly these data are also referred to as ungrounded samples. Detail regarding the second type of ungrounded training data is described further in FIG. 14.

Subject 1340 is an example of, or includes aspects of, the corresponding element described with reference to FIGS. 3, 8, 12, and 14. Relation 1345 is an example of, or includes aspects of, the corresponding element described with reference to FIGS. 8, 12, and 14. Object 1350 is an example of, or includes aspects of, the corresponding element described with reference to FIGS. 8, 12, and 14.

FIG. 14 shows an example of training a machine learning model 1400 using ungrounded training samples according to aspects of the present disclosure. The example shown includes machine learning model 1400, image 1405, input text 1410, image encoder 1415, text encoder 1420, multi-modal encoder 1425, decoder 1430, loss function 1435, subject 1440, relation 1445, and object 1450. Machine learning model 1400 is an example of, or includes aspects of, the corresponding element described with reference to FIGS. 6-8, 13, and 16.

In some embodiments, machine learning model 1400 obtains additional training data including an additional training image (e.g., image 1405), an additional training input (e.g., input text 1410) including an additional subject from image 1405, an additional ground-truth relation of the additional subject to an additional object from the additional training image (e.g., relation 1445). For example, the additional subject is subject 1440, i.e., “a cat”. Additional ground-truth relation is relation 1445, i.e., “plays with”. The additional object from the additional training image is object 1450, i.e., “a toy”. The machine learning model 1400 is trained based on the additional training data.

In some examples, image encoder 1415 is configured to encode the additional training image (e.g., image 1405) to obtain an image embedding. Text encoder 1420 is configured to encode the training input text (e.g., input text 1410) to obtain a text embedding. Multi-modal encoder 1425 combines the image embedding and the text embedding to obtain a combined embedding, where the output text is generated based on the combined embedding. Decoder 1430 generates a predicted output text based on the image embedding and the text embedding. A training component (see FIG. 6) is configured to compute a loss function 1435 based on the predicted output text, the ground-truth relation, where the machine learning model 1400 is trained based on the loss function 1435. Loss function 1435 includes a cross-entropy loss.

Referring to FIG. 14, machine learning model 1400 processes a training sample via a training component for which a [symbol] subject, relation, object [symbol] triplet is provided and without object location (i.e., location for the object is not available during training). In this case, the training component does not backpropagate gradients through the prediction heads corresponding to object location coordinates although machine learning model 1400 makes reasonable predictions based on parameter sharing with other similar training samples that are fully annotated (refer to training the model using fully annotated samples described in FIG. 13).

Alternatively or additionally, the same machine learning model 1400 is trained with ungrounded relation-object pairs for which a set of object box coordinates is not available by optimizing L( [symbol] r, o [symbol] , F_{d}(z)) for samples that do not contain a bounding box corresponding to the object in the relation. In some embodiments, the training component samples a full-length sequence containing a relation-object pair as well as the object location for ungrounded relation-object pairs. During training, the training component skips computing the loss terms (e.g., loss function 1435) for input tokens that are not provided in the ground-truth output sequences (e.g., bounding boxes). Loss function 1435 is an example of, or includes aspects of, the corresponding element described with reference to FIG. 13.

Image 1405 is an example of, or includes aspects of, the corresponding element described with reference to FIGS. 3, 4, 8, and 13. Input text 1410 is an example of, or includes aspects of, the corresponding element described with reference to FIGS. 13 and 16.

Image encoder 1415 is an example of, or includes aspects of, the corresponding element described with reference to FIGS. 6, 7, and 13. Text encoder 1420 is an example of, or includes aspects of, the corresponding element described with reference to FIGS. 6, 7, and 13. Multi-modal encoder 1425 is an example of, or includes aspects of, the corresponding element described with reference to FIGS. 6, 7, 13, and 16. Decoder 1430 is an example of, or includes aspects of, the corresponding element described with reference to FIGS. 6, 7, 13, and 16.

Subject 1440 is an example of, or includes aspects of, the corresponding element described with reference to FIGS. 3, 8, 12, and 13. Relation 1445 is an example of, or includes aspects of, the corresponding element described with reference to FIGS. 8, 12, and 13. Object 1450 is an example of, or includes aspects of, the corresponding element described with reference to FIGS. 8, 12, and 13.

FIG. 15 shows an example of concatenating bounding box and text tokens according to aspects of the present disclosure. The example shown includes input image 1500, quantization process 1505, bounding box data 1510, normalization process 1515, and input query 1520.

In some examples, the machine learning model (as described in FIGS. 6-8, 13-14 and 16) is a multi-modal sequence-to-sequence text generation model. The machine learning model takes bounding boxes as input in addition to text inputs. The machine learning model generates text with bounding boxes as outputs.

In some embodiments, the machine learning model quantizes, via quantization process 1505, the bounding boxes such that the position tokens can be added into text vocabulary. For example, the model normalizes, via normalization process 1515, bounding boxes into [0,1] based on the size of input image 1500, and multiplies the normalized coordinates by the number of position tokens. Therefore, bounding boxes are concatenated with text tokens as inputs and outputs. The machine learning model generates input query 1520 following normalization process 1515.

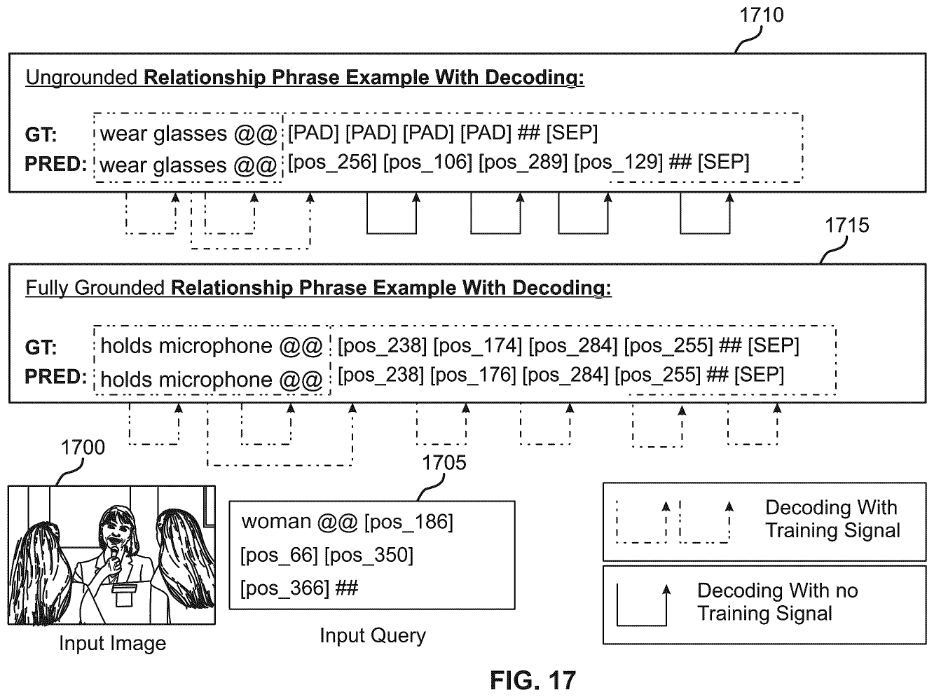

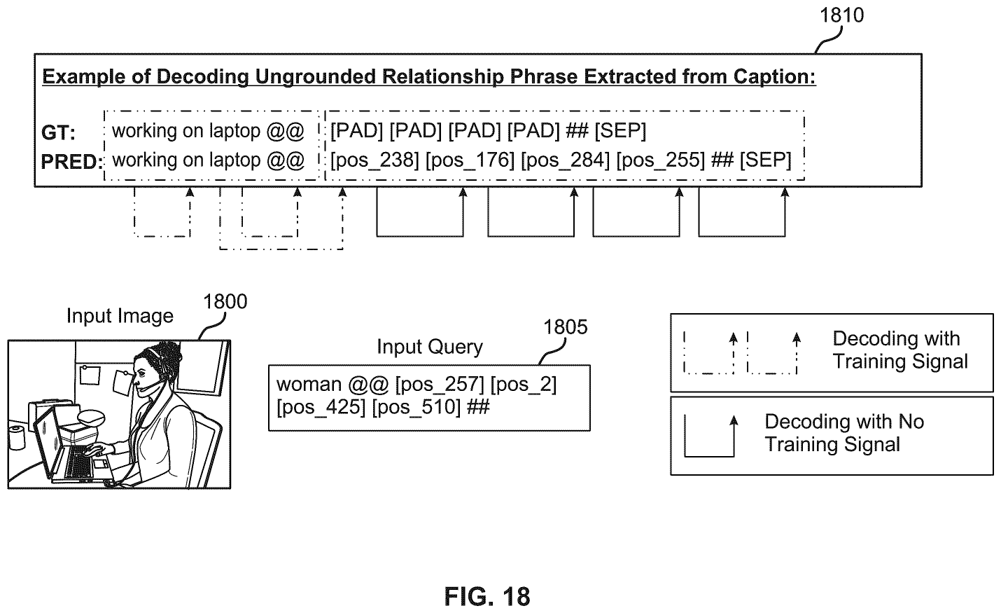

Input image 1500 is an example of, or includes aspects of, the corresponding element described with reference to FIGS. 16-18. Input query 1520 is an example of, or includes aspects of, the corresponding element described with reference to FIGS. 17 and 18.

FIG. 16 shows an example of sequence-to-sequence model for text generation according to aspects of the present disclosure. The example shown includes input image 1600, input text 1605, multi-modal encoder 1610, decoder 1615, output text 1620, and machine learning model 1625. Machine learning model 1625 is an example of, or includes aspects of, the corresponding element described with reference to FIGS. 6-8, 13, and 14.

In some embodiments, machine learning model 1625 is a sequence-to-sequence model trained with cross-entropy loss for text generation. Machine learning model 1625 takes images, subjects, and quantized box information for subjects as inputs. Machine learning model 1625 encodes images and text individually and combines information from images and texts (i.e., different modalities) through multi-modal encoder 1610. Multi-modal encoder 1610 is an example of, or includes aspects of, the corresponding element described with reference to FIGS. 6, 7, 13, and 14.

In some embodiments, decoder 1615 (e.g., a text decoder) takes the last hidden state of multi-modal encoder 1610 as the input to generate a sequence of tokens. In some examples, machine learning model 1625 generates output text 1620 based on the sequence of tokens. Decoder 1615 is an example of, or includes aspects of, the corresponding element described with reference to FIGS. 6, 7, 13, and 14.

Input image 1600 is an example of, or includes aspects of, the corresponding element described with reference to FIGS. 15, 17, and 18. Input text 1605 is an example of, or includes aspects of, the corresponding element described with reference to FIGS. 13 and 14. Output text 1620 is an example of, or includes aspects of, the corresponding element described with reference to FIG. 8.

FIG. 17 shows an example of decoding relation-object pairs and bounding boxes according to aspects of the present disclosure. The example shown includes input image 1700, input query 1705, first decoding example 1710, and second decoding example 1715.

In some embodiments, a two-step decoding process is applied to decode relation-object pairs and bounding boxes separately to maintain the diversity of predictions. The two-step decoding process includes that, first, the text decoder uses beam search to generate possible relation-object pairs for the given image (i.e., input image 1700) and subject, and second, the decoder keeps top-k relation-object pairs and uses them as inputs to generate locations for the top-k relation-object pairs.

In some examples, a subject and location of the subject in input image 1700 are provided. Input query 1705 is “woman @@ [pos_186] [pos_66] [pos_350] [pos_366] ##”. Input query 1705 is input to the machine learning model.

In some cases, the bounding box annotations for target objects are unknown and accordingly the machine learning model puts [PAD] token as placeholder. The training component does not calculate cross-entropy loss when generating position tokens for the target objects (i.e., objects without bounding box annotations). Therefore, the machine learning model is trained with fully grounded data (second decoding example 1715) and data with just text descriptions (first decoding example 1710).

Input image 1700 is an example of, or includes aspects of, the corresponding element described with reference to FIGS. 15, 16, and 18. Input query 1705 is an example of, or includes aspects of, the corresponding element described with reference to FIGS. 15 and 18.

FIG. 18 shows an example of decoding unknown bounding box annotations according to aspects of the present disclosure. The example shown includes input image 1800, input query 1805, and decoding example 1810.

In some embodiments, a machine learning model is trained using training datasets with box annotations and datasets without box annotations. For datasets without box annotations, the training component extracts information from captions for the input images from the datasets without box annotations (i.e., the training dataset does not have box annotations). For example, a caption for input image 1800 is “there is a woman working on the laptop,” the machine learning model extracts “woman-working on-laptop” triplet from the text. That is, input query 1805 is “woman @@ [pos_257] [pos_2] [pos_425] [pos_510] ##”. Input query 1805 is input to the machine learning model. In some examples, a pre-trained query-based object detector takes the extracted triplet as input to obtain a box for the subject “woman”.

Input image 1800 is an example of, or includes aspects of, the corresponding element described with reference to FIGS. 15-17. Input query 1805 is an example of, or includes aspects of, the corresponding element described with reference to FIGS. 15 and 17.

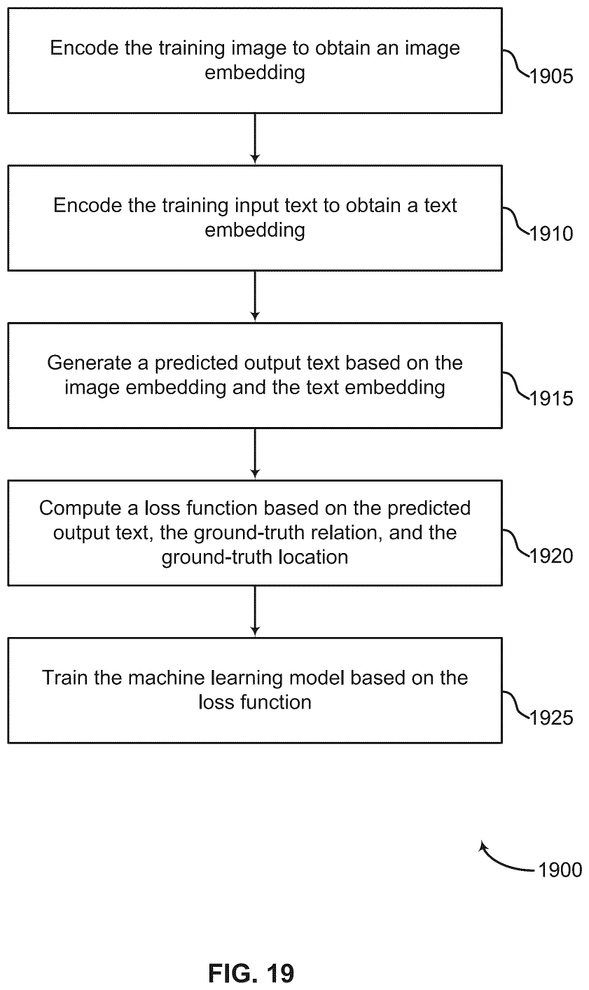

FIG. 19 shows an example of a method 1900 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

Accordingly, during the training process, the parameters and weights of the machine learning model are adjusted to increase the accuracy of the result (i.e., by attempting to minimize a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

At operation 1905, the system encodes the training image to obtain an image embedding. In some cases, the operations of this step refer to, or may be performed by, an image encoder as described with reference to FIGS. 6, 7, 13, and 14.

At operation 1910, the system encodes the training input text to obtain a text embedding. In some cases, the operations of this step refer to, or may be performed by, a text encoder as described with reference to FIGS. 6, 7, 13, and 14.

At operation 1915, the system generates a predicted output text based on the image embedding and the text embedding. In some cases, the operations of this step refer to, or may be performed by, a machine learning model as described with reference to FIGS. 6-8, 13, 14, and 16.

In some examples, the machine learning model based on the present disclosure generates relation-object pairs and bounding boxes as an output text (e.g., a sentence). The bounding box annotations in the training data are optional during training, e.g., machine learning model is trained using training data without the bounding box annotations.

At operation 1920, the system computes a loss function based on the predicted output text, the ground-truth relation, and the ground-truth location. In some cases, the operations of this step refer to, or may be performed by, a training component as described with reference to FIG. 6.

In some embodiments, a standard cross-entropy loss is used to train the machine learning model. Let H (·,·) be the cross-entropy function. The training component computes the cross-entropy between the current target token and generated token conditioned on the input image, subject sequence, and previous tokens as follows:

$${z}_{i} = {F}_{m} ( {F}_{v} ( {I}_{i} ) , {F}_{t} ( 〈 {s}_{i} , {b}_{{s}_{i}} 〉 ) ) \qquad ( 4 )$$

$$L = {\sum }_{i = 1}^{N} {\sum }_{k} H ( {t}_{k} , {F}_{d} ( {t}_{0 : k - 1} , {z}_{i} ) ) \qquad ( 5 )$$

where N is the number of training samples, Iᵢ is the input image, [symbol] sᵢ, bₛ_{ᵢ} [symbol] is an input subject and subject-box encoded as a sequence of tokens, and tₖ is a token at a given timestep k for ground-truth annotation [symbol] rᵢ, oᵢ [symbol] , bₒ_{ᵢ} [symbol] encoded as a sequence of tokens.

For ungrounded samples these tokens tₖ encode exclusively the ground-truth annotation [symbol] rᵢ, oᵢ [symbol] .

At operation 1925, the system trains the machine learning model based on the loss function. In some cases, the operations of this step refer to, or may be performed by, a training component as described with reference to FIG. 6.

The term “loss function” refers to a function that impacts how a machine learning model is trained in a supervised learning model. Specifically, during each training iteration, the output of the model is compared to the known annotation information in the training data. The loss function provides a value for how close the predicted annotation data is to the actual annotation data. After computing the loss function, the parameters of the model are updated accordingly and a new set of predictions are made during the next iteration.

### Decoding Process

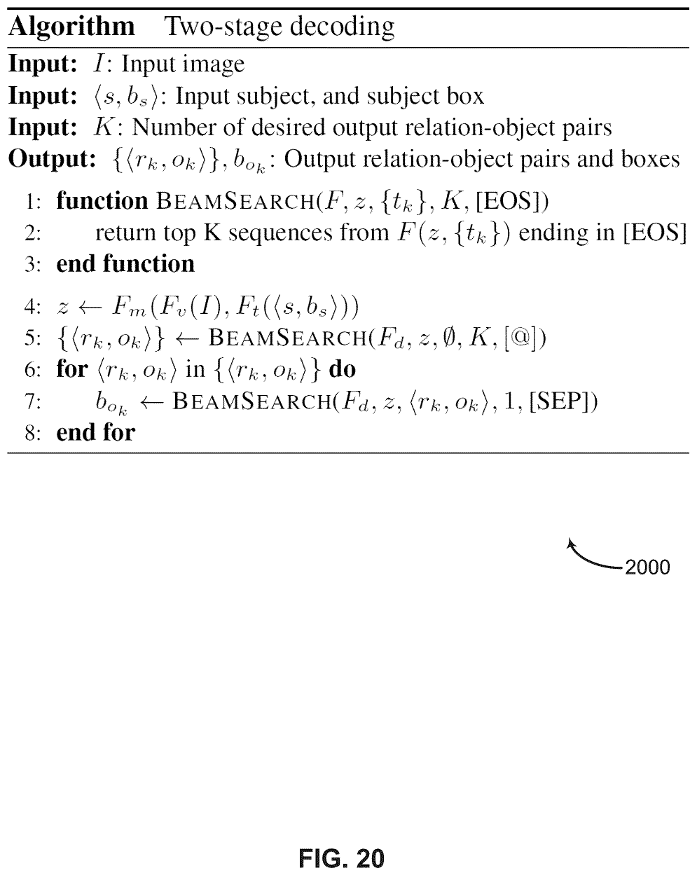

FIG. 20 shows an example of a two-stage decoding process according to aspects of the present disclosure. The example shown includes algorithm 2000. Algorithm 2000 illustrates two-stage decoding process performed by a decoder.

Input to algorithm 2000 is input image I, [symbol] s, bₛ [symbol] , and K. Here, [symbol] s, bₛ [symbol] refers to input subject and subject box. K refers to the number of desired output relation-object pairs. Output from algorithm 2000 is { [symbol] rₖ, oₖ [symbol] }, bₒ_{ₖ}. Here, the output includes relation-object pairs and boxes. At line 1, algorithm is executed 2000 to run function BEAMSEARCH (F, z, {tₖ}, K, [EOS]). At line 2, function BEAMSEARCH returns top K sequences from F(z, {tₖ}) ending in [EOS]. At line 4, z←Fₘ (Fᵥ(I), Fₜ( [symbol] s, bₛ [symbol] )). At line 5, { [symbol] (rₖ, oₖ)}←BEAMSEARCH(F_{d}, z, Φ, K, [@]). Lines 6-7 of algorithm 2000 include a for loop. For [symbol] rₖ, oₖ [symbol] in { [symbol] rₖ, oₖ [symbol] }, algorithm 2000 is executed to run line 7, bₒ_{ₖ}←BEAMSEARCH(F_{d}, z, [symbol] rₖ, oₖ [symbol] , 1, [SEP]). End of the for loop.

Some embodiments sample output relation-object pairs along with object-locations using beam search from the decoder F_{d} such that {(r,o)}, bₒ˜F_{d}. The machine learning model applies two-step decoding to avoid lack of diversity in the predicted relation-object pairs resulting from the disparity in the vocabulary for relation-object tokens and box location tokens. During the two-step decoding process, first, a diverse set of K relation object pairs {(rₖ, oₖ)} are decoded, and then a corresponding set of object boxes bₒ_{ₖ} are decoded conditional on the relation-object pairs, as shown in algorithm 2000.

In some embodiments, a decoder of the machine learning model applies, via algorithm 2000, the beam search function to decode a sequence of K tokens given an input decoder F, conditional state vector z, and a partially generated output sequence tₖ. The beam search function takes a custom end-of-sequence token as a parameter. For example, during the two-step decoding process, the decoder performs beam search to decode relation-object pairs until the end-of-sequence token [@] is encountered. Here, the token [@] is used to separate relation-object pairs and object-location box coordinates. The decoder is configured to decode box locations one by one conditioned on the same input but with a partially generated output sequence comprising the relation-object pair. The decoding process continues until the end-of-sequence token [SEP] is encountered.

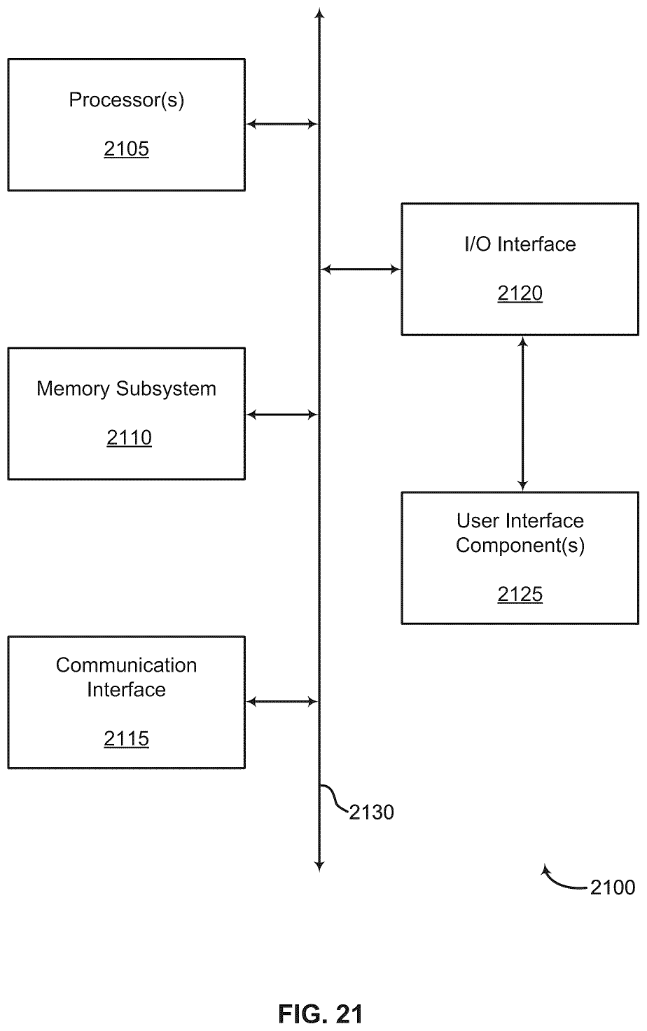

FIG. 21 shows an example of a computing device 2100 according to aspects of the present disclosure. The example shown includes computing device 2100, processor(s) 2105, memory subsystem 2110, communication interface 2115, I/O interface 2120, user interface component(s) 2125, and channel 2130.

In some embodiments, computing device 2100 is an example of, or includes aspects of, image processing apparatus 110 of FIG. 1. In some embodiments, computing device 2100 includes one or more processors 2105 that can execute instructions stored in memory subsystem 2110 to obtain an image and an input text including a subject from the image and a location of the subject in the image; encode the image to obtain an image embedding; encode the input text to obtain a text embedding; and generate an output text based on the image embedding and the text embedding, wherein the output text includes a relation of the subject to an object from the image and a location of the object in the image.

According to some embodiments, computing device 2100 includes one or more processors 2105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some embodiments, memory subsystem 2110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some embodiments, communication interface 2115 operates at a boundary between communicating entities (such as computing device 2100, one or more user devices, a cloud, and one or more databases) and channel 2130 and can record and process communications. In some cases, communication interface 2115 is provided to enable a processing system coupled to a transceiver (e.g., a transmitter and/or a receiver). In some examples, the transceiver is configured to transmit (or send) and receive signals for a communications device via an antenna.

According to some embodiments, I/O interface 2120 is controlled by an I/O controller to manage input and output signals for computing device 2100. In some cases, I/O interface 2120 manages peripherals not integrated into computing device 2100. In some cases, I/O interface 2120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2120 or via hardware components controlled by the I/O controller.

According to some embodiments, user interface component(s) 2125 enable a user to interact with computing device 2100. In some cases, user interface component(s) 2125 include an audio device, such as an external speaker system, an external display device such as a display screen, an input device (e.g., a remote control device interfaced with a user interface directly or through the I/O controller), or a combination thereof. In some cases, user interface component(s) 2125 include a GUI.

### Evaluation

Performance of apparatus, systems and methods of the present disclosure have been evaluated, and results indicate embodiments of the present disclosure have obtained increased performance over existing technology. Example experiments demonstrate that the image processing apparatus based on the present disclosure outperforms conventional systems.

In some example experiments, Recall@K results are recorded. For each subject and its bounding box, the model is configured to keep different numbers of sequences from beam search, which is the mechanism for decoding. For example, Recall@3 indicates the model keeps 3 relation, object, object-boxes with the highest scores. Some embodiments split the outputs into two parts: relation-object (Rel-Object) and object-location (Object-Loc). If one predicted text part among K returned sequences belongs to the ground-truth text part or its synsets, this sample is counted as positive for text evaluation. If one predicted text is “correct”, the model keeps looking at the predicted box, and if the predicted box and ground-truth box have IoU≥0.5, this sample is counted as positive for the bounding box part. In some examples, synset instances are the groupings of synonymous words that express the same concept. <man, rides, horse> and <man, riding, horse> are both correct. The model based on the present disclosure evaluates on predicted text and boxes. In some examples, if <man, rides, horse> is correct, then <person, riding, horse> is also correct.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an image and an input text including a subject from the image and a location of the subject in the image;
encoding the image to obtain an image embedding;
encoding the input text to obtain a text embedding; and
generating an output text based on the image embedding and the text embedding, wherein the output text includes a relation of the subject to an object from the image and a location of the object in the image.

2. The method of claim 1, further comprising:
combining the image embedding and the text embedding to obtain a combined embedding, wherein the output text is generated based on the combined embedding.

3. The method of claim 1, further comprising:
generating a first portion of the output text indicating the relation; and
generating a second portion of the output text indicating the location of the object based on the relation.

4. The method of claim 1, wherein:
the location of the subject comprises coordinates for a bounding box surrounding the subject.

5. The method of claim 1, wherein:
the input text comprises a symbol between the subject and the location of the subject, and wherein the output text comprises the symbol between the relation and the location of the object.

6. The method of claim 1, further comprising:
obtaining the subject in the image; and
generating the input text based on the obtaining.

7. The method of claim 1, further comprising:
modifying the image to obtain a modified image based on the subject, the object, and the relation of the subject to the object.

8. A method comprising:
receiving training data including a training image, a training input text including a subject from the training image, a ground-truth relation of the subject to an object from the training image, and a ground-truth location of the object in the training image; and
training, using the training data, a machine learning model to generate an output text that includes a relation of the subject to the object and a location of the object in the training image.

9. The method of claim 8, further comprising:
obtaining additional training data including an additional training image, an additional training input including an additional subject from the additional training image, an additional ground-truth relation of the additional subject to an additional object from the additional training image, wherein the machine learning model is trained based on the additional training data.

10. The method of claim 9, further comprising:
obtaining a plurality of captions; and
parsing a caption of the plurality of captions, wherein the additional training input is obtained based on the parsing.

11. The method of claim 8, further comprising:
encoding the training image to obtain an image embedding;
encoding the training input text to obtain a text embedding;
generating a predicted output text based on the image embedding and the text embedding; and
computing a loss function based on the predicted output text, the ground-truth relation, and the ground-truth location, wherein the machine learning model is trained based on the loss function.

12. The method of claim 11, further comprising:
combining the image embedding and the text embedding to obtain a combined embedding, wherein the predicted output text is generated based on the combined embedding.

13. The method of claim 8, further comprising:
generating a first portion of the output text indicating the relation; and
generating a second portion of the output text indicating the location of the object based on the relation.

14. An apparatus comprising:
at least one processor;
at least one memory including instructions executable by the at least one processor; and
a machine learning model comprising parameters stored in the at least one memory, wherein the machine learning model is trained to generate an output text including a relation of a subject to an object from an image and a location of the object in the image based on an input text including the subject from the image and a location of the subject in the image.

15. The apparatus of claim 14, further comprising:
an image encoder configured to encode the image to obtain an image embedding.

16. The apparatus of claim 14, further comprising:
a text encoder configured to encode the input text to obtain a text embedding.

17. The apparatus of claim 14, further comprising:
a multi-modal encoder configured to combine an image embedding and a text embedding to obtain a combined embedding, wherein the output text is generated based on the combined embedding.

18. The apparatus of claim 14, further comprising:
a decoder configured to generate a first portion of the output text indicating the relation and a second portion of the output text indicating the location of the object based on the relation.

19. The apparatus of claim 14, further comprising:
a training component configured to compute a loss function based on training data and to train the machine learning model based on the loss function.

20. The apparatus of claim 14, wherein:
the machine learning model obtains the subject in the image, wherein the input text is generated based on the obtaining.
